(19) United States
(12) Patent Application Publication
(10) Pub. No.: US 2018/0121208 A1
(43) Pub. Date: May 3, 2018

(54) INFORMATION PROCESSING APPARATUS AND STARTING METHOD

(71) Applicant: FUJITSU LIMITED, Kawasaki-shi (JP)

(72) Inventor: Kazuya Mikami, Yokohama (JP)

(73) Assignee: FUJITSU LIMITED, Kawasaki-shi (JP)

(21) Appl. No.: 15/791,714

(22) Filed: Oct. 24, 2017

(30) Foreign Application Priority Data
Nov. 2, 2016 (JP) 2016-215466

(51) Int. Cl. G06F 9/44; G06F 13/40; G06F 12/02; G06F 13/42

(52) U.S. Cl. CPC G06F 9/4405; G06F 13/4081; G06F 2212/7208; G06F 13/426; G06F 12/0246

(57) ABSTRACT

An information processing apparatus includes a memory, and a processor coupled to the memory and configured to determine whether a system and a type of an expansion card for communication inserted in a replaceable form are same as a system and a type of an expansion card for communication before replacement, when determining that the system and the type are the same, set specific information of the expansion card for communication before the replacement, and when determining that the system or the type is different, set specific information of the expansion card for communication after the replacement.

### CROSS-REFERENCE TO RELATED APPLICATION

This application is based upon and claims the benefit of priority of the prior Japanese Patent Application No. 2016-215466, filed on Nov. 2, 2016, the entire contents of which are incorporated herein by reference.

### FIELD

The embodiments discussed herein are related to an information processing apparatus and a starting method.

### BACKGROUND

In an expansion card for communication, specific information for a port included in the card is written in a read only memory (ROM) in the card during manufacturing. The specific information is, for example, a media access control (MAC) address of a local area network (LAN) card, a World Wide Name (WWN) of a Fibre Channel card, and a globally unique identifier (GUID) of an InfiniBand card. An expansion card for communication including a plurality of ports has specific information as many as the number of the ports.

A controller of the expansion card for communication acquires the specific information from the ROM and retains the specific information when an information processing apparatus (hereinafter referred to as server), into which the expansion card for communication is inserted, starts. Thereafter, the expansion card for communication and an operating system (OS) perform communication using the specific information retained by the controller of the expansion card for communication.

The specific information is used not only for communication on the OS but also for booting the OS. In a preboot execution environment (PXE) boot and an Internet Small Computer System Interface (iSCSI) boot, which are examples of a network boot, the information processing apparatus designates an internet protocol (IP) address and acquires a boot image. Therefore, a dynamic host configuration protocol (DHCP) server that allocates an IP address to a boot target server and notifies an IP address of an apparatus to which the boot image is distributed is desired.

The DHCP server registers an MAC address of a server desired to be booted in a setting file in advance to perform control to make it possible to boot only the server having the registered MAC address taking into account security.

In a storage area network (SAN) boot, a zone requests to be created by a port of a Fibre Channel card and a storage beforehand. Since a WWN of the Fibre Channel card is used in the creation of the zone, the boot may be performed only from the Fibre Channel card having the registered WWN.

In this way, the specific information of the expansion card for communication is registered as information for booting the OS. Therefore, when the expansion card for communication breaks down and is replaced, the boot of the OS may be unable to be performed unless registered information is changed. In the case of the LAN card, since a MAC address of a replaced LAN card is different from a MAC address before the replacement, an OS that stores a MAC address in a setting file allocates a new device name to a port of the replaced LAN card. Therefore, the OS may be unable to continuously use a previous device name.

As measures against the disadvantages, there is a technique for changing specific information of an expansion card for communication after replacement to specific information prepared in advance and using the expansion card for communication after the replacement. For example, there is a technique in which, after a server blade is turned on and an EFI starts, the EFI reads an HBA identification table recorded in a PCIe switch register and updates an HBA identifier of an HBA mounted on a PCI card. The EFI represents an Extensible Firmware Interface. The HBA represents a Host Bus Adapter. With this technique, even if the PCI card is replaced, it is possible to make it undesirable to register the HBA identifier in an apparatus connected to the PCI card (see Japanese Laid-open Patent Publication No. 2012-150623).

Note that there is a technique in which a remote control system causes devices to store first IDs set by a user and second IDs indicating control targets and a control device determines, using the first IDs and the second IDs, whether the control device associates the devices with the control targets or performs warning. Consequently, it is possible to select the control targets even when the first IDs are redundant (see Japanese Laid-open Patent Publication No. 2011-182329).

There is a technique for storing, in an address storing unit, a MAC address allocated to a network control unit, changing the MAC address stored in the address storing unit, and allocating the MAC address to the network control unit to enable flexible allocation of the MAC address (see Japanese Laid-open Patent Publication No. 2010-233006).

### SUMMARY

According to an aspect of the invention, an information processing apparatus includes a memory, and a processor coupled to the memory and configured to determine whether a system and a type of an expansion card for communication inserted in a replaceable form are same as a system and a type of an expansion card for communication before replacement, when determining that the system and the type are the same, set specific information of the expansion card for communication before the replacement, and when determining that the system or the type is different, set specific information of the expansion card for communication after the replacement.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of an information processing apparatus according to a first embodiment;

FIG. 2 is a diagram illustrating operation during a start and a functional configuration of the information processing apparatus;

FIG. 3 is a diagram illustrating an example of a long term storage table;

FIG. 4 is a diagram illustrating an example of a temporary storage table;

FIG. 5 is a flowchart illustrating a flow of start processing of the information processing apparatus;

FIGS. 6A and 6B are flowcharts illustrating a flow of table preparation processing;

FIG. 7 is a flowchart illustrating a flow of redundancy processing;

FIG. 8 is a flowchart illustrating a flow of specific information determination processing;

FIG. 9 is a diagram illustrating state transition during a configuration change of an expansion slot;

FIG. 10 is a diagram illustrating an initial hardware configuration;

FIG. 11 is a diagram illustrating initial values of the long term storage table;

FIGS. 12A and 12B are diagrams illustrating the long term storage table and the temporary storage table during initial table creation;

FIGS. 13A to 13C are diagrams illustrating the tables after initial specific information determination processing and MAC addresses retained by a LAN controller;

FIGS. 14A and 14B are diagrams illustrating the long term storage table and the temporary storage table during second table creation;

FIGS. 15A to 15C are diagrams illustrating the tables after second specific information determination processing and MAC addresses retained by the LAN controller;

FIG. 16 is a diagram illustrating a hardware configuration after expansion card replacement;

FIG. 17 is a diagram illustrating the long term storage table before determination processing after the expansion card replacement;

FIGS. 18A and 18B are diagrams illustrating the long term storage table and the temporary storage table during table creation after the expansion card replacement;

FIGS. 19A to 19C are diagrams illustrating the tables after specific information determination processing after the expansion card replacement and MAC addresses retained by the LAN controller;

FIG. 20 is a diagram illustrating a hardware configuration after a configuration change;

FIG. 21 is a diagram illustrating a long term storage table before determination processing after the configuration change;

FIGS. 22A and 22B are diagrams illustrating the long term storage table and the temporary storage table during table creation after the configuration change;

FIGS. 23A to 23C are diagrams illustrating the tables after specific information determination processing after the configuration change and specific information retained by a controller;

FIG. 24 is a diagram illustrating a hardware configuration after LAN card replacement;

FIG. 25 is a diagram illustrating the long term storage table before determination processing after the LAN card replacement;

FIGS. 26A and 26B are diagrams illustrating the long term storage table and the temporary storage table during table creation after the LAN card replacement;

FIGS. 27A and 27B are diagrams illustrating the long term storage table and the temporary storage table after redundancy processing after the LAN card replacement;

FIGS. 28A to 28C are diagrams illustrating the tables after specific information determination processing after the LAN card replacement and MAC addresses retained by the LAN controller;

FIG. 29 is a diagram illustrating a hardware configuration after expansion card for communication removal;

FIG. 30 is a diagram illustrating the long term storage table before determination processing after the expansion card for communication removal;

FIGS. 31A and 31B are diagrams illustrating the long term storage table and the temporary storage table during table creation after the expansion card for communication removal;

FIGS. 32A and 32B are diagrams illustrating the long term storage table and the temporary storage table after redundancy processing after the expansion card for communication removal;

FIGS. 33A and 33B are diagrams illustrating the long term storage table and the temporary storage table after specific information determination processing after the expansion card for communication removal;

FIG. 34A is a diagram illustrating a hardware configuration before expansion card addition;

FIG. 34B is a diagram illustrating a hardware configuration after the expansion card addition;

FIG. 35 is a diagram illustrating the long term storage table before determination processing after the expansion card addition;

FIGS. 36A and 36B are diagrams illustrating the long term storage table and the temporary storage table during table creation after the expansion card addition;

FIGS. 37A and 37B are diagrams illustrating the long term storage table and the temporary storage table after redundancy processing after the expansion card addition;

FIGS. 38A and 38B are diagrams illustrating the long term storage table and the temporary storage table after specific information determination processing after the expansion card addition;

FIG. 39 is a diagram illustrating a hardware configuration of an information processing apparatus according to a second embodiment; and

FIG. 40 is a flowchart illustrating a flow of processing by an interrupt processing unit.

### DESCRIPTION OF EMBODIMENTS

In the technique for changing specific information of an expansion card for communication after replacement to specific information prepared in advance and using the expansion card for communication after the replacement, the expansion card for communication may be unable to be replaced with an expansion card for communication of a different system or a different type. A system of the expansion card for communication is a system based on a communication standard such as a system of a LAN card, a system of a Fibre Channel card, or a system of an InfiniBand card. A type of the expansion card for communication is a type based on a hardware configuration such as a type based on a mounted chip, a type based on communication speed, or a type based on the number of ports among expansion cards for communication of the same system.

For example, when the expansion card for communication is replaced with an expansion card for communication with a large number of ports, since only pieces of specific information as many as the number of ports of the explanation card for communication before the replacement are prepared, not all of the pieces of specific information of the expansion card for communication may be changed to specific information stored in advance. When the expansion card for communication is replaced with an expansion card for communication of a different system, communication may be unable to be performed.

In one aspect, an object of the present disclosure is to enable replacement with an expansion card for communication of a different system or a different type.

Embodiments disclosed by this application are explained in detail below with reference to the drawings. Note that the embodiments do not limit a disclosed technique.

### First Embodiment

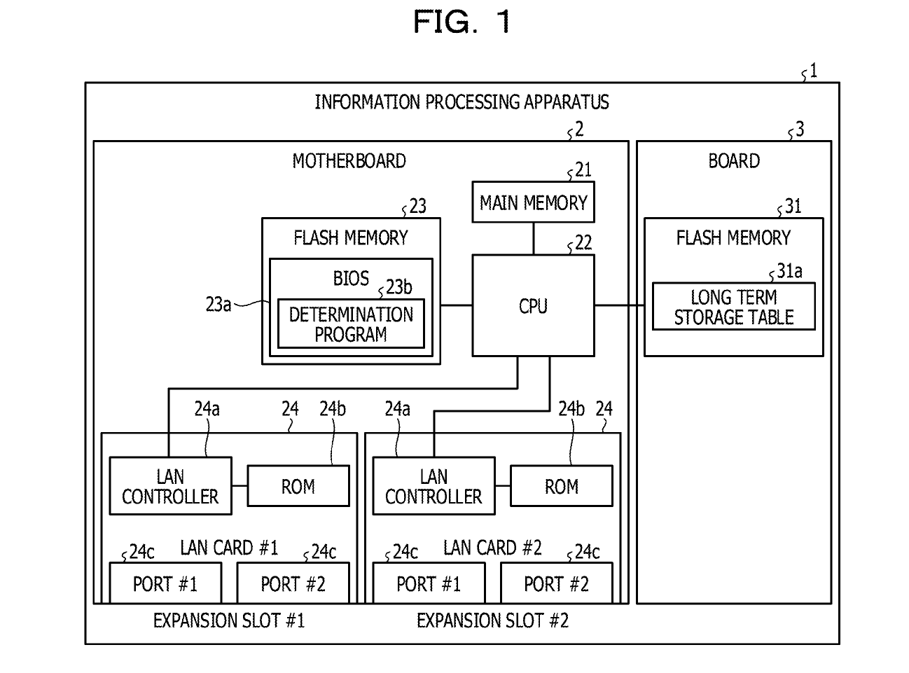

First, a hardware configuration of an information processing apparatus according to a first embodiment is explained. FIG. 1 is a diagram illustrating the hardware configuration of an information processing apparatus according to the first embodiment. As illustrated in FIG. 1, an information processing apparatus 1 according to the first embodiment includes a motherboard 2 and a board 3. The motherboard 2 is a main electronic circuit board of the information processing apparatus 1. The board 3 is a board for storing information that requests to be retained when a power supply of the information processing apparatus 1 is turned off.

The motherboard 2 includes a main memory 21, a central processing unit (CPU) 22, a flash memory 23, and two expansion slots represented by expansion slots #1 and #2. A LAN card 24 represented by a LAN card #1 is inserted into the expansion slot #1. The LAN card 24 represented by a LAN card #2 is inserted into the expansion slot #2. An expansion card other than the LAN card 24 is inserted into the expansion slots #1 and #2.

The main memory 21 is a memory that stores a computer program, a result halfway in execution of the computer program, and the like. The CPU 22 is a central processing device that reads out the computer program from the main memory 21 and executes the computer program. The flash memory 23 is a nonvolatile memory that stores a BIOS 23a.

The BIOS 23a is a computer program read out to the main memory 21 during a start of the information processing apparatus 1 and executed by the CPU 22. The BIOS 23a performs, for example, a boot of an OS. The BIOS 23a includes a determination program 23b.

The determination program 23b is a program for performing determination processing for determining specific information used by an expansion card for communication. A card inserted into the expansion slots #1 and #2 is sometimes changed, for example, from the LAN card 24 to the LAN card 24 including a large number of ports or an expansion card for communication of a different system. Therefore, the determination program 23b determines, whether addition, removal, replacement, or the like of an inserted expansion card is performed and the inserted expansion card is changed during the start of the information processing apparatus and determines specific information used by the expansion card according to a situation of the change, during the start of the information processing apparatus 1. Note that details of the determination program 23b are explained below.

The LAN card 24 is an expansion card for communication for performing communication using a LAN. The LAN card 24 includes a LAN controller 24a, a read only memory (ROM) 24b, and two ports 24c represented by ports #1 and #2. The LAN controller 24a controls communication performed using a LAN. The ROM 24b is a nonvolatile memory that stores MAC addresses and IDs of the LAN card 24. The IDs include a vendor ID and a device ID concerning a chip mounted on the LAN card 24 and a subsystem vendor ID and a subsystem ID concerning a subsystem. The port 24c is an interface for inputting and outputting data.

The board 3 includes a flash memory 31. The flash memory 31 is a nonvolatile memory that stores a long term storage table 31a. Since the flash memory 31 requests to retain the long term storage table 31a even during replacement of the motherboard 2 (for example, during failure of the LAN card 24 on the motherboard 2), the flash memory 31 is mounted on the board 3 different from the motherboard 2. The long term storage table 31a is a table in which information concerning the LAN card 24 mounted on the information processing apparatus 1 is registered for each of the ports 24c. Note that details of the long term storage table 31a are explained below.

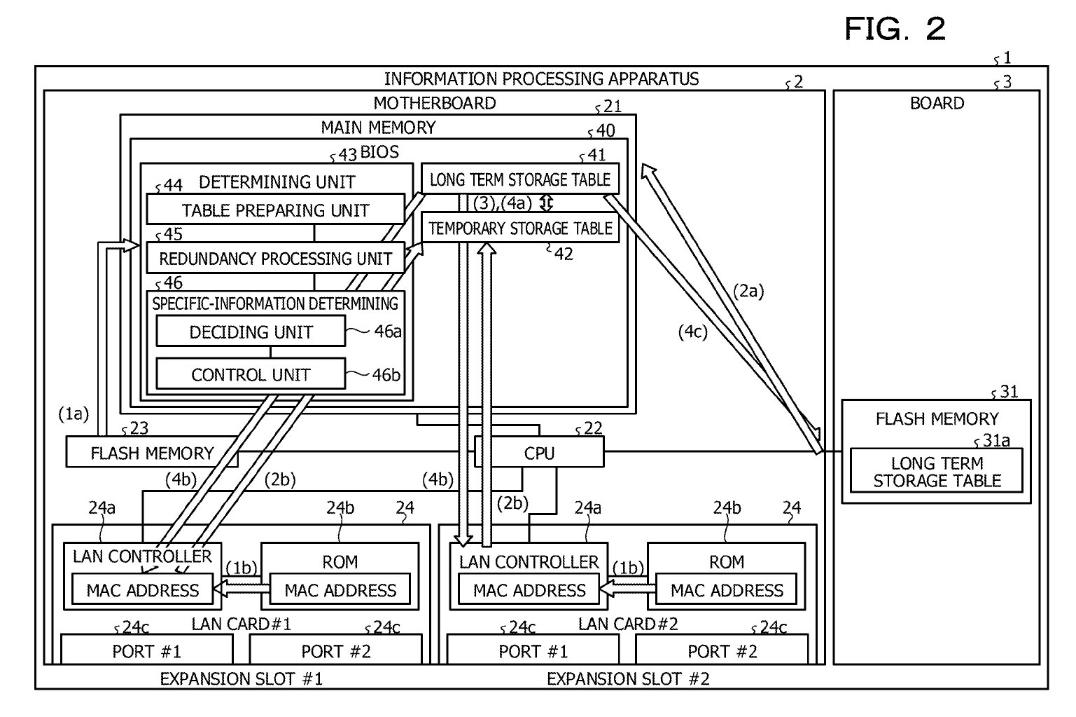

Operation during the start and a functional configuration of the information processing apparatus 1 are explained. FIG. 2 is a diagram illustrating the operation during the start and the functional configuration of the information processing apparatus 1. As illustrated in FIG. 2, when the information processing apparatus 1 is powered on, the information processing apparatus 1 reads out the BIOS 23a from the flash memory 23 and writes the BIOS 23a in the main memory 21 as a BIOS 40. At this point, the determination program 23b included in the BIOS 23a is also loaded on the main memory 21.

The determination program 23b is executed by the CPU 22 to thereby operate as a determining unit 43 (1a). The determining unit 43 includes a table preparing unit 44, a redundancy processing unit 45, and a specific-information determining unit 46. When the BIOS 40 is executed by the CPU 22 and initialization processing of a PCI device is performed, for example, the LAN controller 24a of the LAN card 24 acquires specific information from the ROM 24b and retains the specific information (1b).

After the initialization of the PCI device ends, the table preparing unit 44 of the determining unit 43 starts processing. The table preparing unit 44 reads out the long term storage table 31a from the flash memory 31 and writes the long term storage table 31a in the main memory 21 as a long term storage table 41 (2a). Thereafter, the table preparing unit 44 creates a temporary storage table 42 based on information (an insertion slot number, a port number, an ID, and specific information) concerning the inserted card (2b). The temporary storage table 42 is a table in which information concerning an inserted expansion card is registered.

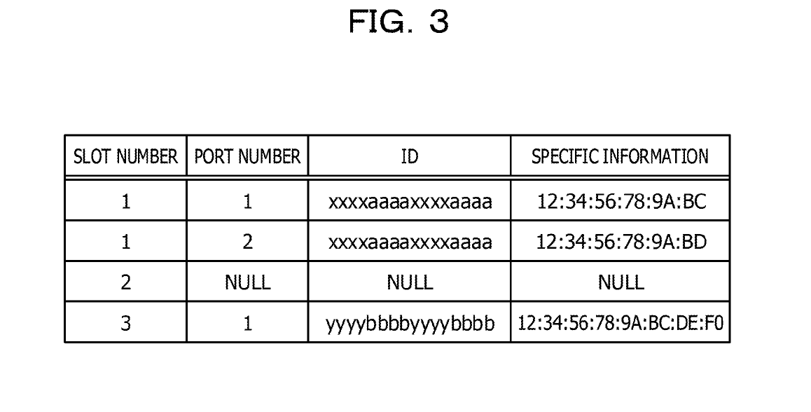

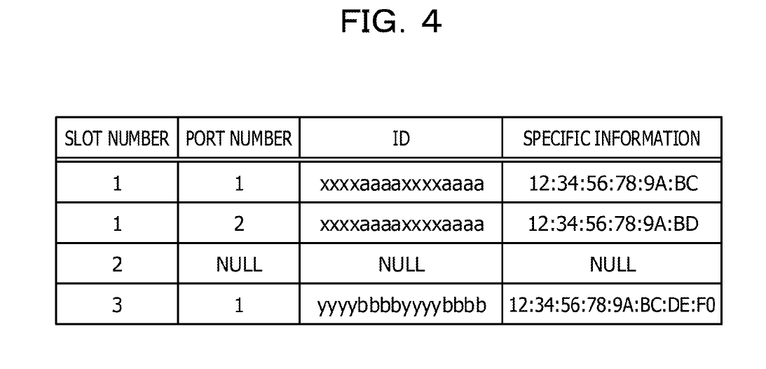

FIG. 3 is a diagram illustrating an example of the long term storage table 41. FIG. 4 is a diagram illustrating an example of the temporary storage table 42. As illustrated in FIGS. 3 and 4, the long term storage table 41 and the temporary storage table 42 respectively store slot numbers, port numbers, IDs, and specific information for each of ports. The slot number is a number for identifying an expansion slot. The port number is a number for identifying a port in an expansion card for communication.

When an expansion card is not inserted, the port number, the ID, and the specific information are NULL. In the case of the temporary storage table 42, in order to discriminate whether information of the long term storage table 41 is left when the expansion card is inserted or an expansion card other than the expansion card for communication is inserted, the port number is 0 when the expansion card other than the expansion card for communication is inserted.

For example, in FIG. 3, an ID of a port, a slot number of which is 1 and a port number of which is 1, is xxxxaaaaxxxxaaaa and specific information of the port is 12:34:56:78:9A:BC. An expansion card is not inserted into an expansion slot, a slot number of which is 2. Therefore, a port number, an ID, and specific information are NULL. Note that, in FIGS. 3 and 4, there are three expansion slots.

Referring back to FIG. 2, the redundancy processing unit 45 performs redundancy processing in order to avoid redundancy of specific information (3). Specifically, the redundancy processing unit 45 compares respective expansion slots of the temporary storage table 42 with the slot number, the ID, and the specific information of the long term storage table 41 to determine presence or absence of redundancy. When there is redundancy, the redundancy processing unit 45 invalidates redundant information of the long term storage table 41. Note that, when an inserted expansion card is inserted into another expansion slot, redundancy of the specific information occurs between the long term storage table 41 and the temporary storage table 42.

The specific-information determining unit 46 performs processing for determining specific information used by the expansion card for communication. The specific-information determining unit 46 includes a deciding unit 46a and a control unit 46b. The deciding unit 46a compares the respective expansion slots of the temporary storage table 42 with the ID and the specific information of the long term storage table 41 and performs determination concerning a replacement state of the expansion card (4a).

For example, the deciding unit 46a determines that the expansion card for communication is not replaced. Alternatively, the deciding unit 46a determines that the expansion card for communication is replaced with an expansion card for communication of the same type having the same number of ports. Alternatively, the deciding unit 46a determines that the expansion card for communication is replaced with an expansion card for communication of a different type having a different number of ports. Alternatively, the deciding unit 46a determines that the expansion card for communication is replaced with an expansion card other than the expansion card for communication.

The control unit 46b performs processing based on a determination result of the deciding unit 46a. For example, when the LAN card 24 is replaced with the LAN card 24 of the same type having the same number of ports, since specific information in the past is used as the specific information, the control unit 46b rewrites the specific information stored by the LAN controller 24a (4b). On the other hand, when a configuration change is performed, for example, the LAN card 24 is replaced with an expansion card for communication of a different system or an expansion card for a different use, the control unit 46b updates the long term storage table 41 and saves the long term storage table 41 in the flash memory 31 as the long term storage table 31a (4c).

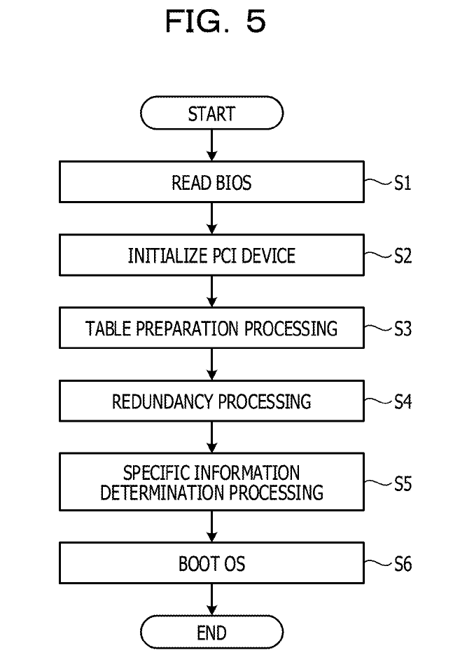

A flow of start processing of the information processing apparatus 1 is explained. FIG. 5 is a flowchart illustrating the flow of the start processing of the information processing apparatus 1. When the power supply of the information processing apparatus 1 is turned on, as illustrated in FIG. 5, the information processing apparatus 1 reads the BIOS 23a (step S1) and stores the BIOS 23a in the main memory 21 as the BIOS 40. The information processing apparatus 1 executes the BIOS 40 and initializes the PCI device (step S2).

The table preparing unit 44 performs table preparation processing (step S3). In the table preparation processing, the table preparing unit 44 reads the long term storage table 31a into the main memory 21 and creates the temporary storage table 42 based on information concerning an inserted expansion card.

The redundancy processing unit 45 performs the redundancy processing (step S4). In the redundancy processing, the redundancy processing unit 45 checks redundancy of the specific information between the long term storage table 41 and the temporary storage table 42. When there is redundancy, the redundancy processing unit 45 invalidates redundant information of the long term storage table 41.

The specific-information determining unit 46 performs specific information determination processing (step S5). The specific-information determining unit 46 determines specific information used by the expansion card for communication referring to the temporary storage table 42 and the long term storage table 41 and updates the long term storage table 41 and saves the long term storage table 41 as the long term storage table 31a. The information processing apparatus 1 performs a boot of the OS (step S6).

In this way, the information processing apparatus 1 performs the redundancy check of the specific information and the determination of the specific information used by the expansion card for communication using the long term storage table 41 and the temporary storage table 42. Consequently, it is possible to replace the expansion card for communication with an expansion card for communication of a different system or a different type.

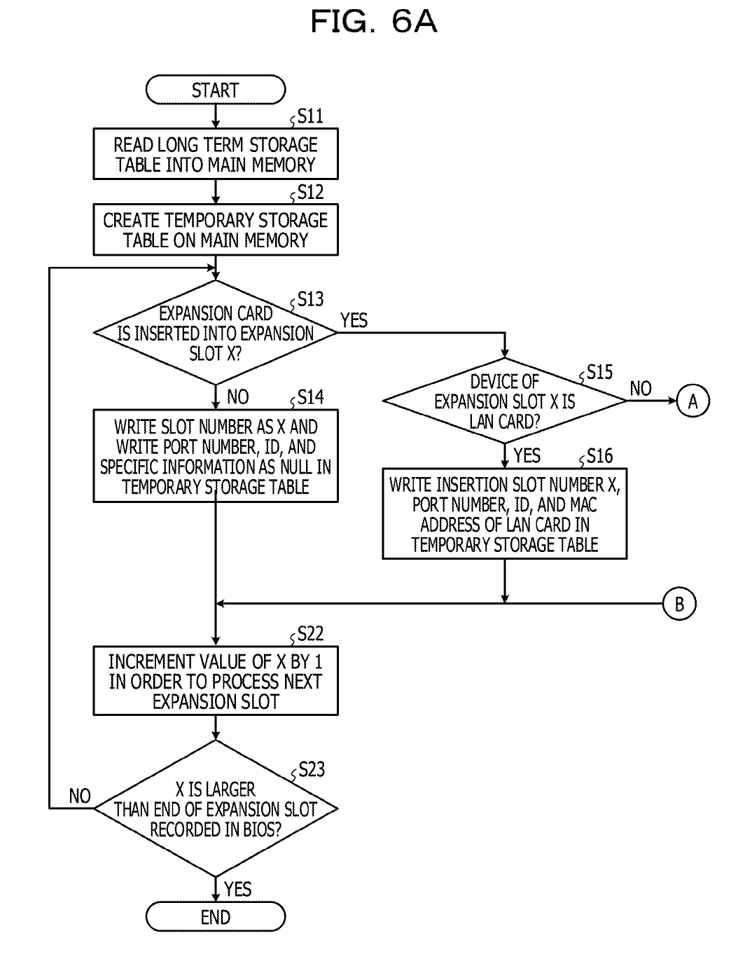

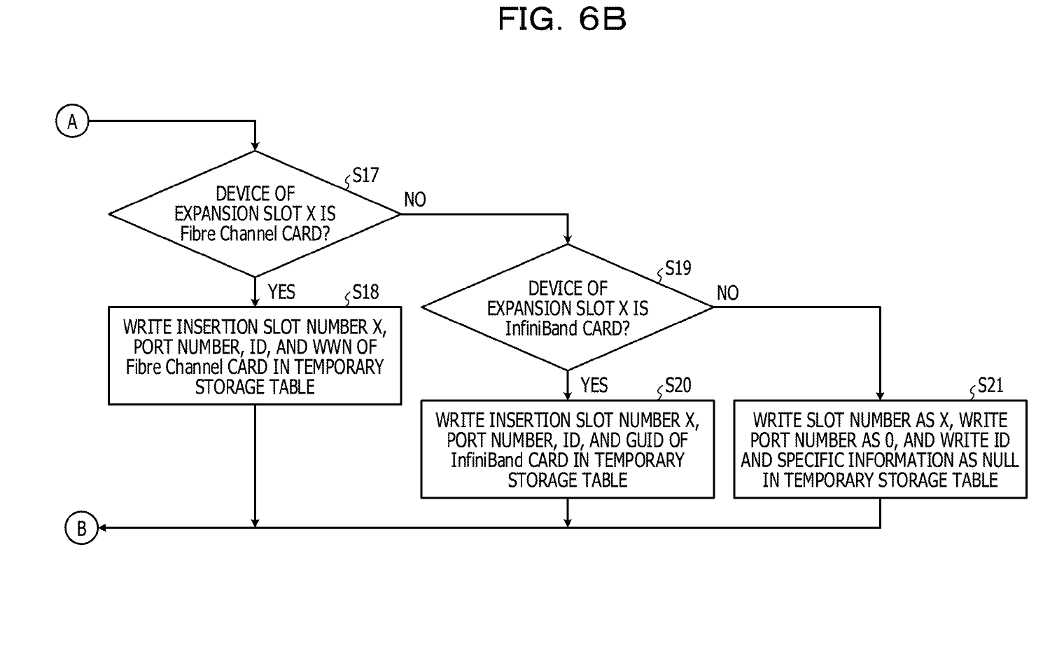

FIG. 6 is a flowchart illustrating a flow of the table preparation processing. Note that, in FIG. 6, it is assumed that initial value of X is 1. As illustrated in FIG. 6, the table preparing unit 44 reads the long term storage table 31a stored in the flash memory 31 into the main memory 21 (step S11) and saves the long term storage table 31a as the long term storage table 41. The table preparing unit 44 creates the temporary storage table 42 on the main memory 21 (step S12). At this point, the temporary storage table 42 does not have values.

The table preparing unit 44 determines whether an expansion card is inserted into an expansion slot X (step S13). When an expansion card is not inserted into the expansion slot X, the table preparing unit 44 writes a slot number as X and writes a port number, an ID, and specific information in the temporary storage table 42 as NULL (step S14). The table preparing unit 44 shifts to step S22.

On the other hand, when an expansion card is inserted into the expansion slot X, the table preparing unit 44 determines whether a device of the expansion slot X is the LAN card 24 (step S15). When the table preparing unit 44 requests the expansion card to send a MAC address and a value of the MAC address is returned from the expansion card, the table preparing unit 44 determines that the device of the expansion slot X is the LAN card 24. When the device of the expansion slot X is the LAN card 24, the table preparing unit 44 writes an insertion slot number X, a port number, an ID, and a MAC address of the LAN card 24 in the temporary storage table 42 (step S16) and shifts to step S22.

On the other hand, when the device of the expansion slot X is not the LAN card 24, the table preparing unit 44 determines whether the device of the expansion slot X is a Fibre Channel card (step S17). When the table preparing unit 44 requests the expansion card to send a WWN and a value of the WWN is returned, the table preparing unit 44 determines that the device of the expansion slot X is a Fibre Cannel card. In the case of the Fibre Channel card, the table preparing unit 44 writes an insertion slot number X, a port number, an ID, and a WWN of the Fibre Channel card in the temporary storage table 42 (step S18) and shifts to step S22.

On the other hand, when the device of the expansion slot X is not a Fibre Channel card, the table preparing unit 44 determines whether the device of the expansion slot X is an InfiniBand card (step S19). When the table preparing unit 44 requests the expansion card to send a GUID and a value of the GUID is returned, the table preparing unit 44 determines that the device of the expansion slot X is the InfiniBand card.

In the case of the InfiniBand card, the table preparing unit 44 writes an insertion slot number X, a port number, an ID, and a GUID of the InfiniBand card in the temporary storage table 42 (step S20) and shifts to step S22. On the other hand, when the device of the expansion slot X is not an InfiniBand card, since the device is not an expansion card for communication, the table preparing unit 44 writes a slot number as X, writes a port number as 0, and writes an ID and specific information as NULL in the temporary storage table 42 (step S21).

The table preparing unit 44 increments a value of X in order to process the next expansion slot (step S22) and determines whether X is larger than the end of the expansion slot recorded in the BIOS 40 (step S23). When X is not larger than the end of the expansion slot recorded in the BIOS 40, the table preparing unit 44 returns to step S13. When X is larger than the end of the expansion slot, the table preparing unit 44 ends the processing.

In this way, the table preparing unit 44 prepares the long term storage table 41 and the temporary storage table 42 in the main memory 21. Consequently, the information processing apparatus 1 may perform the redundancy check of the specific information and the determination of specific information used by the expansion card for communication. Note that the table preparing unit 44 may perform the preparation of the temporary storage table 42 before the preparation of the long term storage table 41.

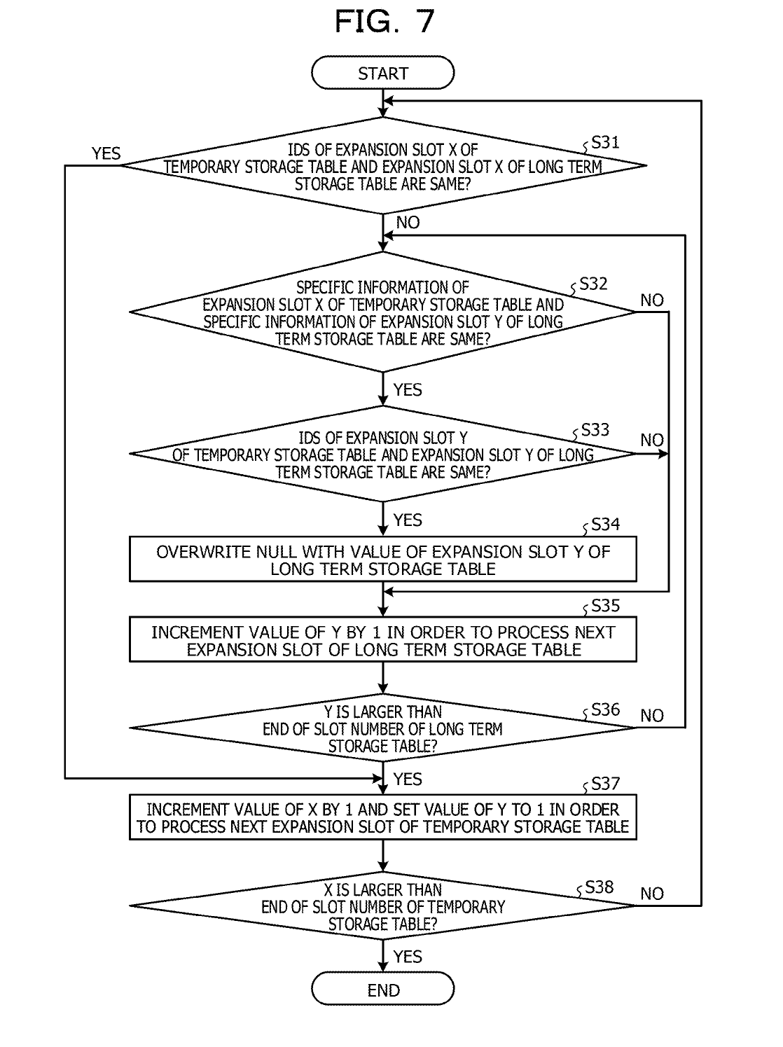

FIG. 7 is a flowchart illustrating a flow of the redundancy processing. Note that, in FIG. 7, it is assumed that initial values of X and Y are 1. As illustrated in FIG. 7, the redundancy processing unit 45 determines whether IDs of the expansion slot X of the temporary storage table 42 and the expansion slot X of the long term storage table 41 are the same (step S31). When the IDs are the same, as explained below, the specific information of the temporary storage table 42 is overwritten with the specific information of the long term storage table 41 and is not redundant. Therefore, the redundancy processing unit 45 proceeds to step S37 to check the next expansion slot.

On the other hand, when the IDs are not the same, the redundancy processing unit 45 determines whether specific information of the expansion slot X of the temporary storage table 42 and specific information of the expansion slot Y of the long term storage table 41 are the same (step S32). When the pieces of specific information are not the same, since there is no redundancy and there is no problem, the redundancy processing unit 45 proceeds to step S35.

On the other hand, when the pieces of specific information are the same, the redundancy processing unit 45 determines whether IDs of the expansion slot Y of the temporary storage table 42 and the expansion slot Y of the long term storage table 41 are the same (step S33). When the IDs are not the same, since the expansion card for communication is replaced with an expansion card for communication of a different system or a different type, as explained below, the specific information of the slot number Y of the long term storage table 41 is overwritten with the specific information of the slot number Y of the temporary storage table 42. Therefore, there is no redundancy and there is no problem, the redundancy processing unit 45 proceeds to step S35.

On the other hand, when the IDs are the same, the specific information of the expansion card for communication inserted into the expansion slot Y is overwritten with the specific information of the slot number Y of the long term storage table 41 to be redundant. Therefore, the redundancy processing unit 45 overwrites NULL with a value of the expansion slot Y of the long term storage table 41 (step S34). That is, the redundancy processing unit 45 deletes values of rows in which the port number is 1 or larger numbers in the slot number Y and rewrites values of the remaining port number, ID, and specific information to NULL.

The redundancy processing unit 45 increments a value of Y by 1 in order to process the next expansion slot of the long term storage table 41 (step S35) and determines whether Y is larger than the end of the slot number of the long term storage table 41 (step S36). When Y is not larger than the end of the slot number of the long term storage table 41, the redundancy processing unit 45 returns to step S32. On the other hand, when Y is larger than the end of the slot number of the long term storage table 41, the redundancy processing unit 45 increments the value of X by 1 in order to process the next expansion slot of the temporary storage table 42 and sets the value of Y to 1 (step S37).

The redundancy processing unit 45 determines whether X is larger than the end of the slot number of the temporary storage table 42 (step S38). When X is not larger than the end of the slot number, the redundancy processing unit 45 returns to step S31. When X is larger than the end of the slot number, the redundancy processing unit 45 ends the processing.

In this way, the redundancy processing unit 45 checks redundancy of the specific information. Consequently, the information processing apparatus 1 may be able to reduce occurrence of a communication failure.

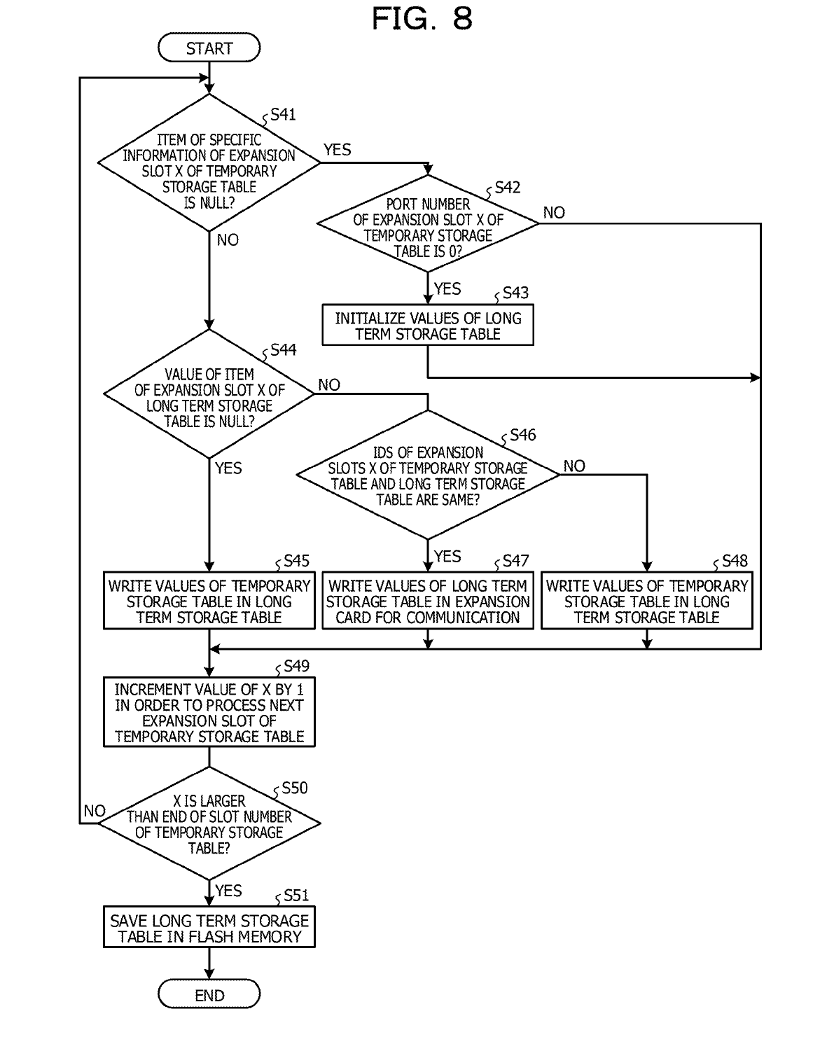

FIG. 8 is a flowchart illustrating a flow of the specific information determination processing. Note that, in FIG. 8, it is assumed that an initial value of X is 1. As illustrated in FIG. 8, the specific-information determining unit 46 determines whether an item of the specific information of the expansion slot X of the temporary storage table 42 is NULL (step S41).

When the item of the specific information is NULL, the specific-information determining unit 46 determines that an expansion card is not inserted or an expansion card other than the expansion card for communication is inserted. The specific-information determining unit 46 determines whether the port number of the expansion slot X of the temporary storage table 42 is 0 (step S42). When the port number is not 0, the specific-information determining unit 46 determines that an expansion card is not inserted and shifts to step S49 for processing of the next expansion slot.

On the other hand, when the port number is 0, the specific-information determining unit 46 determines that an expansion card other than the expansion card for communication is inserted. Since the specific-information determining unit 46 does not have to store specific information, the specific-information determining unit 46 initializes values of the long term storage table 41 (step S43). Targets of the initialization are items (a slot number, a port number, an ID, and specific information) of the expansion slot X. The specific-information determining unit 46 shifts to step S49 to perform processing of the next expansion slot.

When the item of the specific information of the expansion slot X of the temporary storage table 42 is NULL, the specific-information determining unit 46 determines whether a value of the item of the expansion slot X of the long term storage table 41 is NULL (step S44). When the value of the item is NULL, since the expansion card is an expansion card for communication added anew, the specific-information determining unit 46 writes values of the temporary storage table 42 in the long term storage table 41 (step S45).

On the other hand, when the value of the item of the expansion slot X of the long term storage table 41 is not NULL, for insertion of the expansion card for communication, the specific-information determining unit 46 determines whether IDs of the expansion slots X of the temporary storage table 42 and the long term storage table 41 are the same (step S46).

When the IDs are the same, the specific-information determining unit 46 determines that the inserted expansion card for communication is an expansion card for communication of the same system and the same type as the previous expansion card for communication and writes values of the long term storage table 41 in the expansion card for communication (step S47). On the other hand, when the IDs are not the same, the specific-information determining unit 46 determines that the expansion card for communication is replaced with an expansion card for communication having a different ID and writes values of the temporary storage table 42 (values of the items of the expansion slot X) in the long term storage table 41 (step S48).

The specific-information determining unit 46 increments the value of X by 1 in order to process the next expansion slot of the temporary storage table 42 (step S49) and determines whether X is larger than the end of the slot number of the temporary storage table 42 (step S50). When X is not larger than the end of the slot number of the temporary storage table 42, the specific-information determining unit 46 returns to step S41. On the other hand, when X is larger than the end of the slot number of the temporary storage table 42, the specific-information determining unit 46 saves the long term storage table 41 in the flash memory 31 (step S51).

In this way, the specific-information determining unit 46 determines the specific information used by the expansion card for communication using the long term storage table 41 and the temporary storage table 42. Consequently, it is possible to replace the expansion card for communication with an expansion card for communication of a different system or a different type.

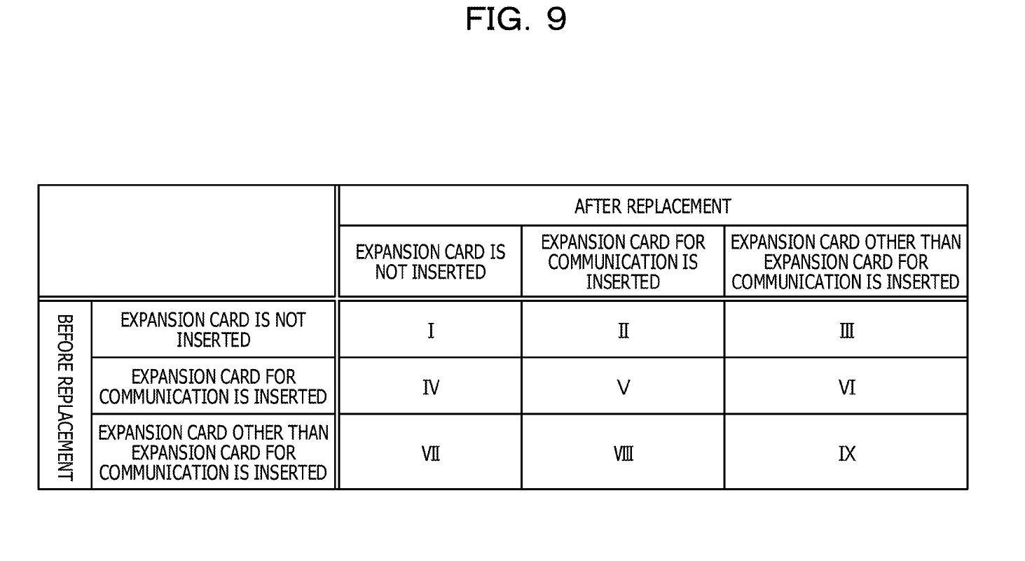

An example of replacement of an expansion card for communication is explained. FIG. 9 is a diagram illustrating a state transition during a configuration change of an expansion slot. As illustrated in FIG. 9, as states before replacement and after replacement, there are three states of a state in which an expansion card is not inserted, a state in which an expansion card for communication is inserted, and a state in which an expansion card other than the expansion card for communication is inserted. Therefore, there are the following nine state transitions Ito IX in expansion slots.

I: An expansion card is not inserted before and after the configuration change

II: An expansion card for communication is additionally inserted into a slot into which an expansion card is not inserted

III: An expansion card other than the expansion card for communication is additionally inserted into the slot into which an expansion card is not inserted

IV: An inserted expansion card for communication is removed

V: The inserted expansion card for communication

i: is not replaced

ii: is replaced with an expansion card for communication of the same system and the same type because of a failure

iii: is replaced with an expansion card for communication of a different system or a different type because of a configuration change

VI: The inserted expansion card for communication is replaced with an expansion card other than the expansion card for communication

VII: An inserted expansion card, which is an expansion card other than the expansion card for communication, is removed

VIII: The inserted expansion card, which is the expansion card other than the expansion card for communication, is replaced with the expansion card for communication

IX: The inserted expansion card, which is the expansion card other than the expansion card for communication,

i: is not replaced

ii: is replaced with an expansion card of a different system other than the expansion card for communication

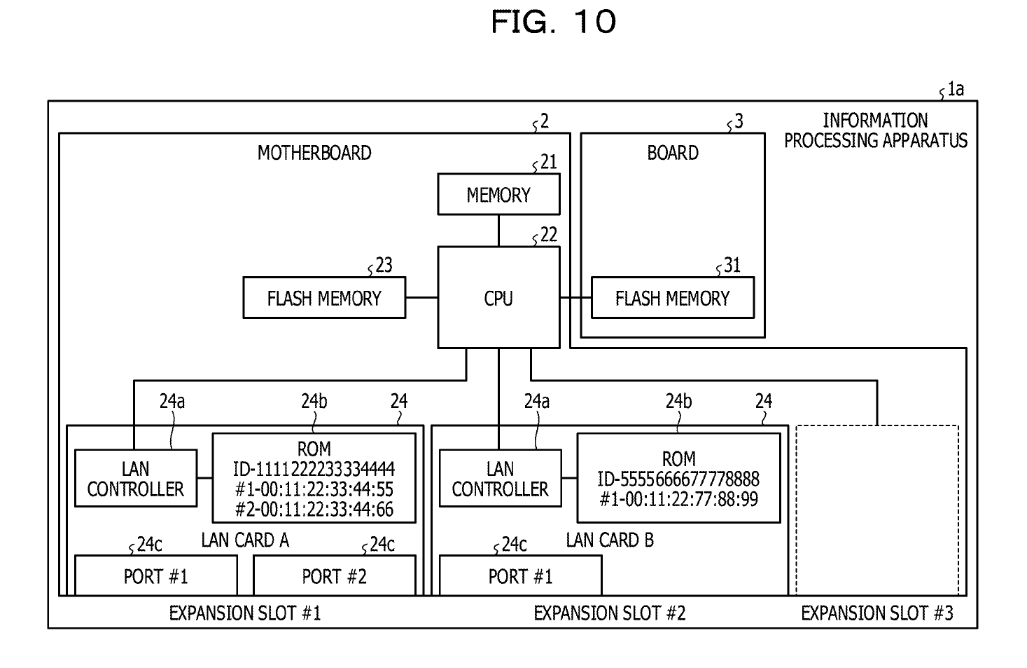

FIG. 10 is a diagram illustrating an initial hardware configuration. Note that, for convenience of explanation, functional units playing the same roles as the units illustrated in FIG. 1 are denoted by the same reference numerals and signs and detailed explanation of the functional units is omitted. As illustrated in FIG. 10, an information processing apparatus 1a includes three expansion slots. A LAN card A including two ports is inserted into an expansion slot #1. A LAN card B including one port is inserted into an expansion slot #2. An expansion slot #3 is empty.

An ID of the LAN card A is 1111222233334444. A MAC address of a port #1 of the LAN card A is 00:11:22:33:44:55. A MAC address of a port #2 of the LAN card A is 00:11:22:33:44:66. An ID of the LAN card B is 5555666677778888. A MAC address of the port #1 of the LAN card B is 00:11:22:77:88:99.

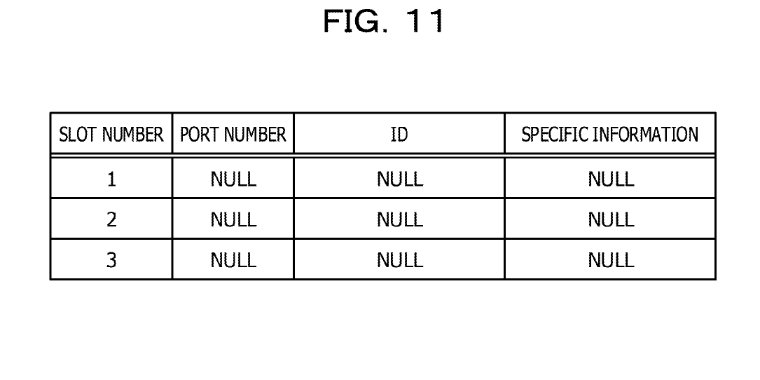

FIG. 11 is a diagram illustrating initial values of the long term storage table 31a. As illustrated in FIG. 11, initial values of port numbers, IDs, and specific information of three expansion slots are NULL.

During initial power-on of the information processing apparatus 1a illustrated in FIG. 10, first, the BIOS 23a is read. Initialization and the like of the LAN card 24 are performed. After the initialization of the LAN card 24 is finished, the determining unit 43 starts operation.

The table preparing unit 44 reads the long term storage table 31a stored in the flash memory 31 onto the main memory 21 and creates the temporary storage table 42 not including values. The table preparing unit 44 confirms whether an expansion card is inserted in order from the expansion slot #1.

Concerning the expansion slot #1, since the LAN card A is inserted into the expansion slot #1, the table preparing unit 44 reads information such as a port number, an ID, and a MAC address retained by the LAN controller 24a and adds the information to the temporary storage table 42. The LAN card A inserted into the expansion slot #1 has two MAC addresses. Therefore, the table preparing unit 44 adds a port number, an ID, and specific information in the temporary storage table 42 concerning a MAC address of a first port and thereafter adds a row and adds a port number, an ID, and specific information concerning a MAC address of a second port as well.

Concerning the expansion slot #2, as in the expansion slot #1, since the LAN card B is inserted into the expansion slot #2, the table preparing unit 44 adds a port number, an ID, and specific information to the temporary storage table 42. Since an expansion card is not inserted into the expansion slot #3, the table preparing unit 44 adds items of a port number, an ID, and specific information as NULL.

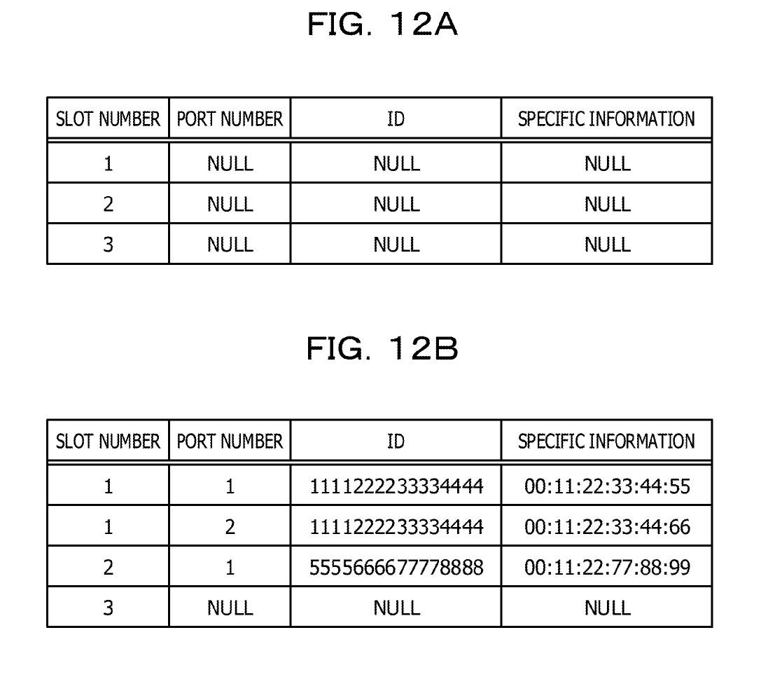

FIGS. 12A and 12B are diagrams illustrating the long term storage table 41 and the temporary storage table 42 during initial table creation. FIG. 12A illustrates the long term storage table 41. FIG. 12B illustrates the temporary storage table 42. As illustrated in FIG. 12A, in the long term storage table 41, a port number, an ID, and specific information are initialized as NULL. As illustrated in FIG. 12B, IDs and specific information respectively retained by the LAN card A and the LAN card B inserted into the expansion slot #1 and the expansion slot #2 are registered in the temporary storage table 42.

The redundancy processing unit 45 performs the redundancy processing according to the flowchart of FIG. 7. Concerning the expansion slot #1 of the temporary storage table 42, since an ID and specific information coinciding with an ID and specific information of the expansion slot #1 are absent in the long term storage table 41, the redundancy processing unit 45 determines that the expansion slot #1 is not redundant. The redundancy processing unit 45 performs the same determination concerning the expansion slot #2 as well. Since an ID of the expansion slot #3 of the temporary storage table 42 coincides with an ID of the expansion slot #3 of the long term storage table 41, the redundancy processing unit 45 determines that the expansion slot #3 is not redundant. Therefore, the redundancy processing unit 45 determines that there is no redundancy concerning all the expansion slots.

The specific-information determining unit 46 performs the specific information determination processing according to the flowchart of FIG. 8. Concerning the expansion slot #1, there is a value in an ID of the temporary storage table 42 and a value of an ID of the long term storage table 41 is NULL. Therefore, the specific-information determining unit 46 writes values of the temporary storage table 42 in the long term storage table 41.

Concerning the expansion slot #1 of the temporary storage table 42, since there is information for two ports, the specific-information determining unit 46 writes a port number in the long term storage table 41 as 1 and thereafter adds a row, sets a port number to 2 and adds an ID and specific information. Concerning the expansion slot #2, the specific-information determining unit 46 performs the same determination as the determination concerning the expansion slot #1. However, since information in the expansion slot #2 is information for one port, the specific-information determining unit 46 writes a port number as 1 and shifts to processing of the next expansion slot. Values of an ID and specific information of the expansion slot #3 in the temporary storage table 42 are NULL. Therefore, the specific-information determining unit 46 does not perform processing on the long term storage table 41 and the expansion card.

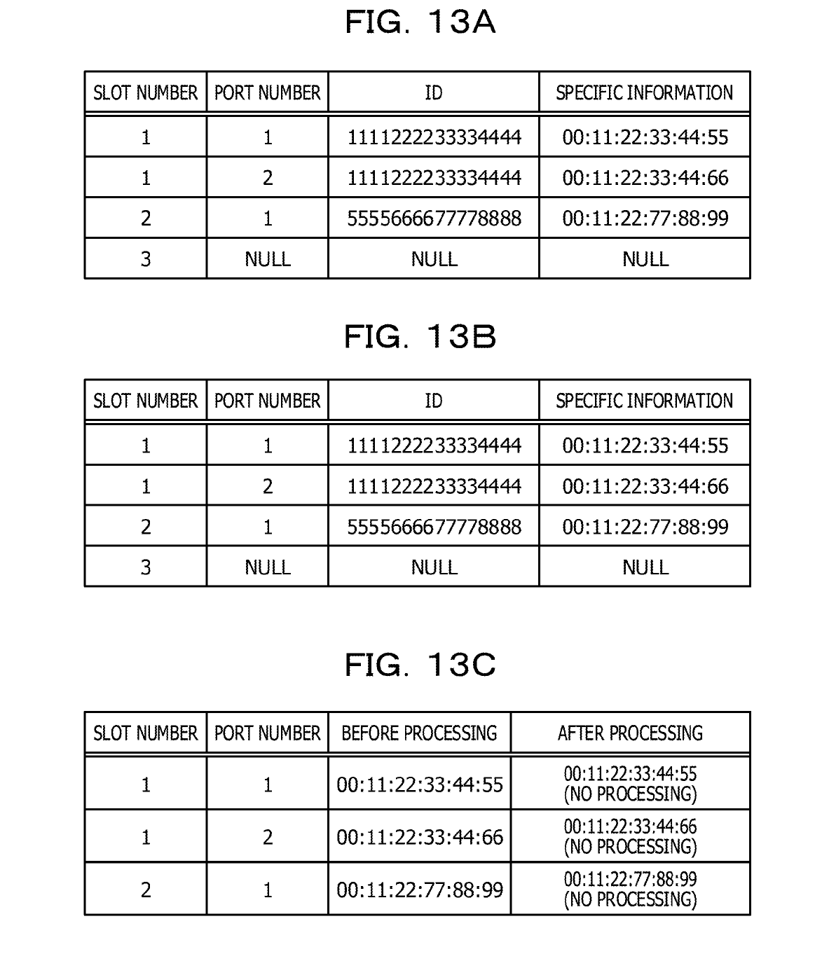

FIGS. 13A to 13C are diagrams illustrating the tables after initial specific information determination processing and MAC addresses retained by the LAN controller 24a. FIG. 13A illustrates the long term storage table 41. FIG. 13B illustrates the temporary storage table 42. FIG. 13C illustrates the MAC addresses retained by the LAN controller 24a. As illustrated in FIGS. 13A and 13B, concerning the expansion slots with the slot numbers 1 and 2, information of the temporary storage table 42 is written in the long term storage table 41. As illustrated in FIG. 13C, the MAC addresses retained by the LAN controller 24a are the same before and after the specific information determination processing.

After the processing concerning the expansion slot #3, the information processing apparatus 1a writes the long term storage table 41 in the flash memory 31 and boots an OS. Since the long term storage table 31a is created by the operation explained above, thereafter, when the information processing apparatus 1a is powered on, the information processing apparatus 1a determines specific information based on the information of the long term storage table 31a.

In the case of second and subsequent power-on, the information processing apparatus 1a performs operation based on the state transition illustrated in FIG. 9. First, operation performed when an expansion card inserted into an expansion slot is not changed is explained. That is, operation in the case of the state transition Vi is explained concerning the expansion slots #1 and #2. Operation in the case of the state transition I is explained concerning the expansion slot #3.

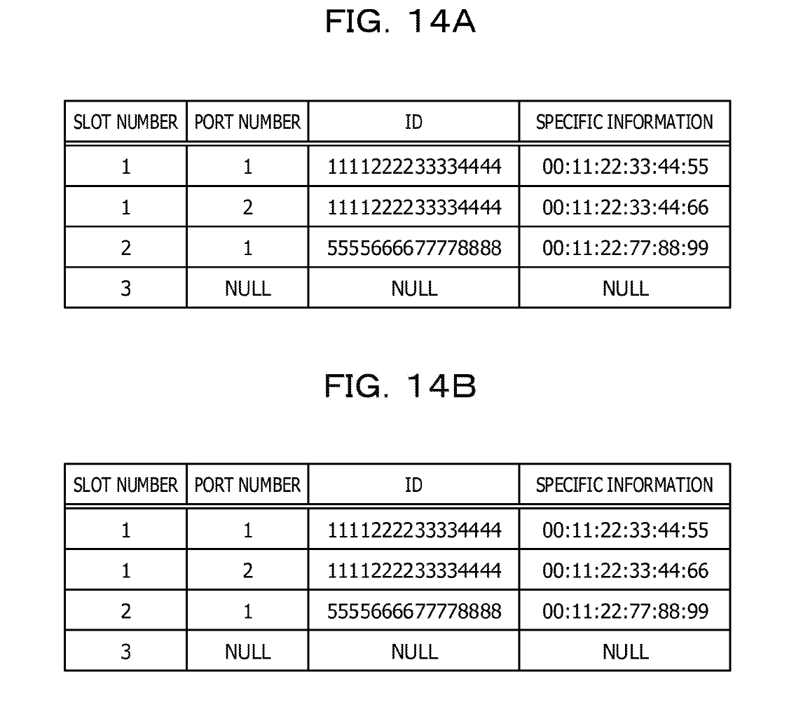

After the BIOS 40 performs initialization of the expansion card, the table preparing unit 44 develops the long term storage table 41 and the temporary storage table 42 illustrated in FIGS. 14A and 14B on the main memory 21 according to the flowchart of FIG. 6. Since the expansion card inserted into the expansion slot is not changed, the temporary storage table 42 illustrated in FIG. 14B is the same as the temporary storage table 42 illustrated in FIG. 13B.

The redundancy processing unit 45 performs the redundancy processing according to the flowchart of FIG. 7. Concerning the expansion slot #1, as illustrated in FIGS. 14A and 14B, since an ID (1111222233334444) of the temporary storage table 42 and an ID (1111222233334444) of the long term storage table 41 are the same, the redundancy processing unit 45 determines that redundancy does not occur and proceeds to processing of the next expansion slot. Concerning the expansion slots #2 and #3, similarly, since an ID of the temporary storage table 42 and an ID of the long term storage table 41 are the same, the redundancy processing unit 45 determines that redundancy does not occur and ends the redundancy processing.

The specific-information determining unit 46 performs the specific information determination processing according to the flowchart of FIG. 8. Concerning the expansion slot #1, a value of specific information of the temporary storage table 42 is other than NULL and IDs of the temporary storage table 42 and the long term storage table 41 coincide with each other. Therefore, the specific-information determining unit 46 overwrites MAC addresses of the port #1 and the port #2 retained by the LAN controller 24a of the LAN card A with values of the MAC addresses stored in the long term storage table 41.

Concerning the expansion slot #2, similarly, the specific-information determining unit 46 overwrites a MAC address of the port #1 retained by the LAN controller 24a of the LAN card B with a value of the MAC address stored in the long term storage table 41. Values of an ID and specific information of the expansion slot #3 in the temporary storage table are NULL. Therefore, the specific-information determining unit 46 does not perform processing on the long term storage table 41 and the expansion card.

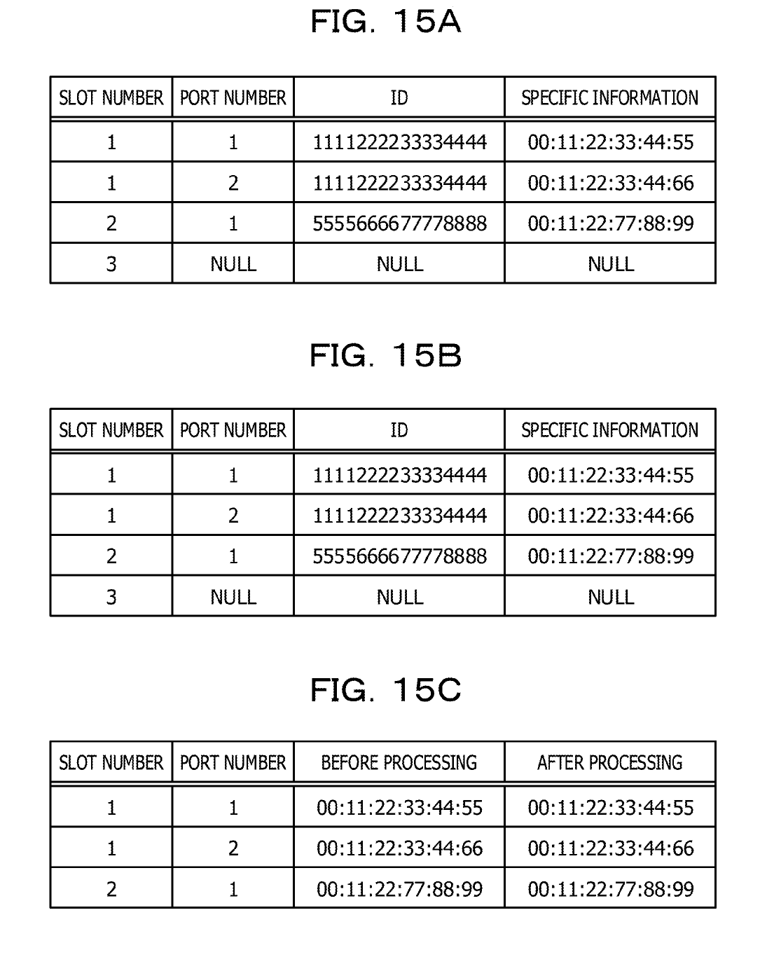

FIGS. 15A to 15C are diagram illustrating the tables after second specific information determination processing and MAC addresses retained by the LAN controller 24a. FIG. 15A illustrates the long term storage table 41. FIG. 15B illustrates the temporary storage table 42. FIG. 15C illustrates the MAC addresses retained by the LAN controller 24a. Since an expansion card inserted into an expansion slot is not changed, FIGS. 13A to 13C and FIGS. 15A to 15C are the same.

After the processing concerning the expansion slot #3, the information processing apparatus 1a writes the long term storage table 41 in the flash memory 31 and boots the OS. When an apparatus configuration is not changed by the operation explained above, the information processing apparatus la may use the same MAC addresses.

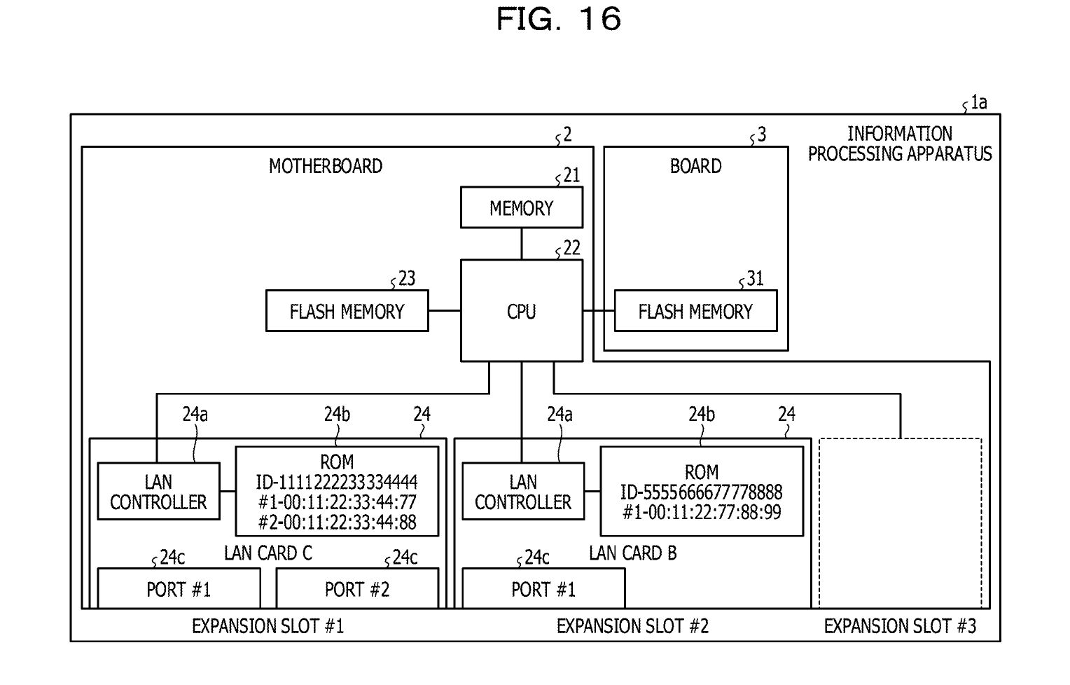

The operation of the information processing apparatus 1a at the time when the expansion card is replaced is explained. That is, operation in the case of the state transition Vii is explained concerning the expansion slot #1. Operation in the case of the state transition Vi is explained concerning the expansion slot #2. Operation in the case of the state transition I is explained concerning the expansion slot #3. FIG. 16 is a diagram illustrating a hardware configuration after expansion card replacement. FIG. 16 is a hardware configuration diagram of the information processing apparatus 1a illustrated in FIG. 10 in which the LAN card A inserted into the expansion slot #1 breaks down and is replaced with a LAN card C of the same system and the same type. As illustrated in FIG. 16, an ID of the LAN card C is 1111222233334444, a MAC address of the port #1 is 00:11:22:33:44:77, and a MAC address of the port #2 is 00:11:22:33:44:88.

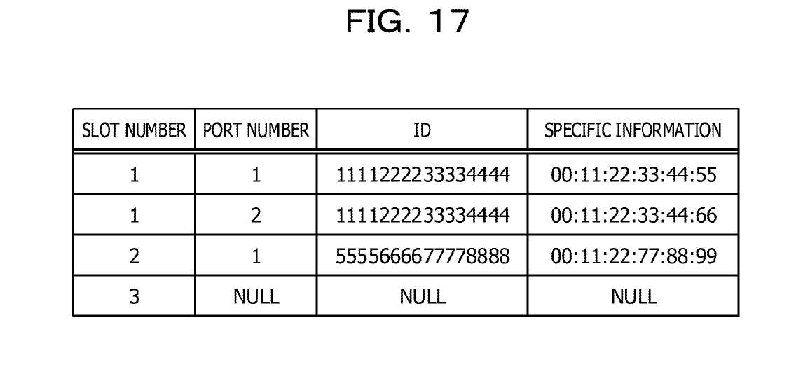

FIG. 17 is a diagram illustrating the long term storage table 31a before determination processing after the expansion card replacement. The same information as the information of the long term storage table 41 illustrated in FIG. 15A is registered in the long term storage table 31a.

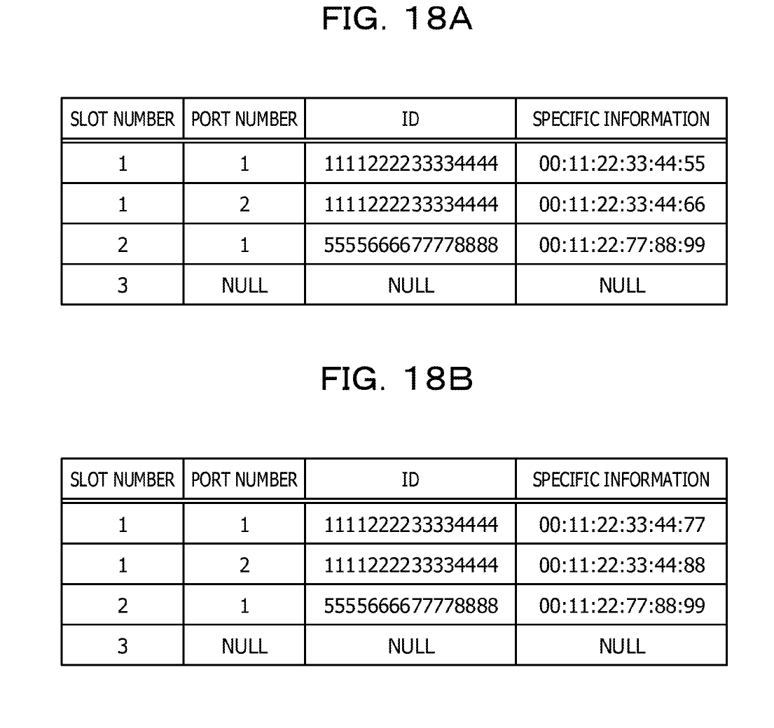

In the case of power-on after the replacement of the expansion card, after the BIOS 23a performs initialization of the expansion card, the table preparing unit 44 develops the long term storage table 41 and the temporary storage table 42 illustrated in FIGS. 18A and 18B on the main memory 21 according to the flowchart of FIG. 6. As illustrated in FIG. 18B, an ID of the LAN card C and MAC addresses of the ports #1 and #2 are registered in the temporary storage table 42.

The redundancy processing unit 45 performs the redundancy processing according to the flowchart of FIG. 7. A card of the expansion slot #1 is a card of the same system and the same type as a card before replacement and an ID of the card is the same. Therefore, the redundancy processing unit 45 determines that redundancy does not occur. Concerning the expansion slots #2 and #3, as in the information processing apparatus 1a illustrated in FIG. 10, the redundancy processing unit 45 determines that there is no redundancy.

The specific-information determining unit 46 performs the specific information determination processing according to the flowchart of FIG. 8. Concerning the expansion slot #1, values of specific information of the temporary storage table 42 and the long term storage table 41 are other than NULL. IDs of the temporary storage table 42 and the long term storage table 41 coincide with each other. Therefore, the specific-information determining unit 46 overwrites MAC addresses of the port #1 and the port #2 retained by the LAN controller 24a of the LAN card C with values of MAC addresses stored by the long term storage table 41. Concerning the expansion slots #2 and #3, the specific-information determining unit 46 performs the same processing as the processing performed on the information processing apparatus 1a illustrated in FIG. 10.

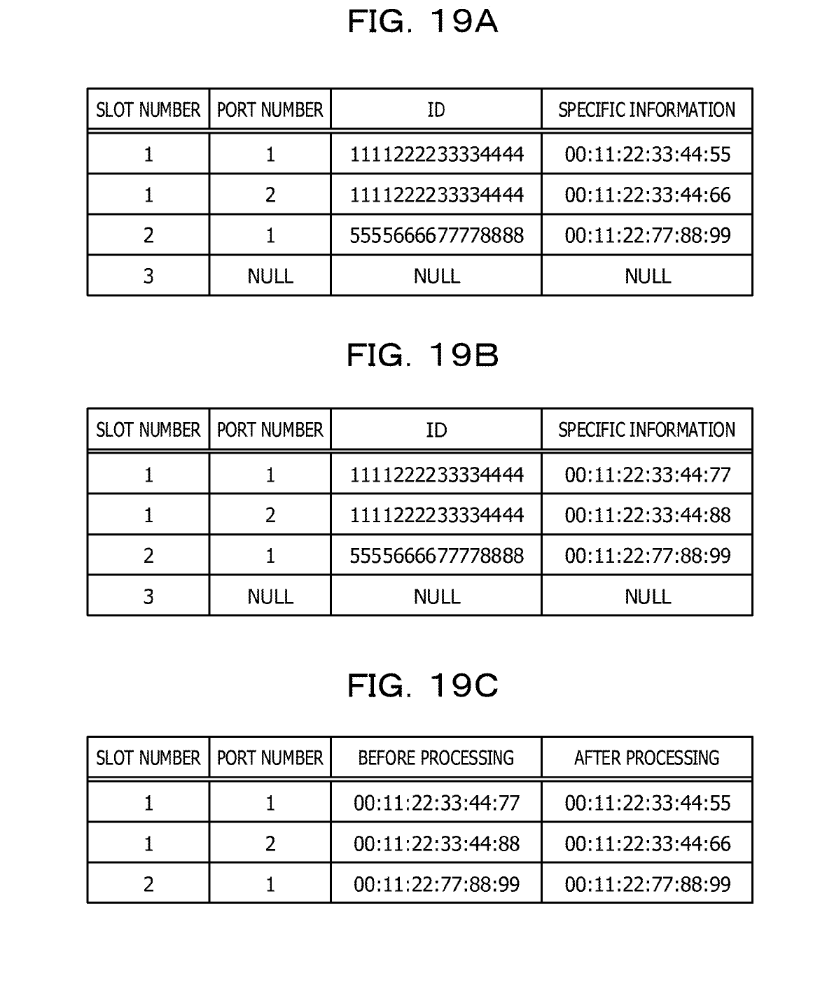

FIGS. 19A to 19C are diagrams illustrating the tables after the specific information determination processing after the expansion card replacement and MAC addresses retained by the LAN controller 24a. FIG. 19A illustrates the long term storage table 41. FIG. 19B illustrates the temporary storage table 42. FIG. 19C illustrates MAC addresses retained by the LAN controller 24a. As illustrated in FIG. 19C, MAC addresses retained by the LAN controller 24a concerning the expansion slot #1 are rewritten from 00:11:22:33:44:77 and 00:11:22:33:44:88 before processing to 00:11:22:33:44:55 and 00:11:22:33:44:66 after processing.

After the processing on the expansion slot #3, the information processing apparatus 1a writes the long term storage table 41 in the flash memory 31 and boots the OS. When the inserted expansion card is changed to a card of the same system and the same type by the operation explained above, the information processing apparatus 1a may succeed and use, without the user performing work, MAC addresses (specific information) used before.

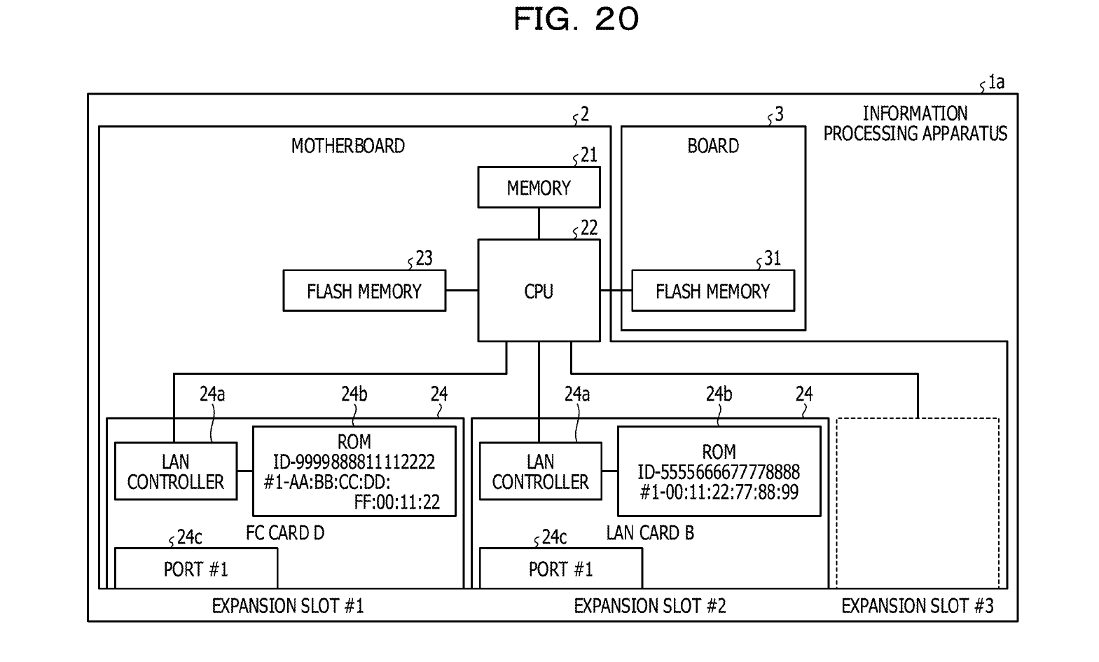

The operation of the information processing apparatus 1a at the time when an apparatus configuration is changed is explained. That is, operation in the case of the state transition Viii is explained concerning the expansion slot #1. Operation in the case of the state transition Vi is explained concerning the expansion slot #2. Operation in the case of the state transition I is explained concerning the expansion slot #3. FIG. 20 is a diagram illustrating a hardware configuration after the configuration change. FIG. 20 is a hardware configuration diagram of the information processing apparatus 1a illustrated in FIG. 16 in which the configuration of the apparatus is changed and an FC card D is inserted into the expansion slot #1. The FC card is a Fibre Channel card. As illustrated in FIG. 20, an ID of the FC card D is 9999888811112222 and a WWN of the port #1 is AA:BB:CC:DD:FF:00:11:22.

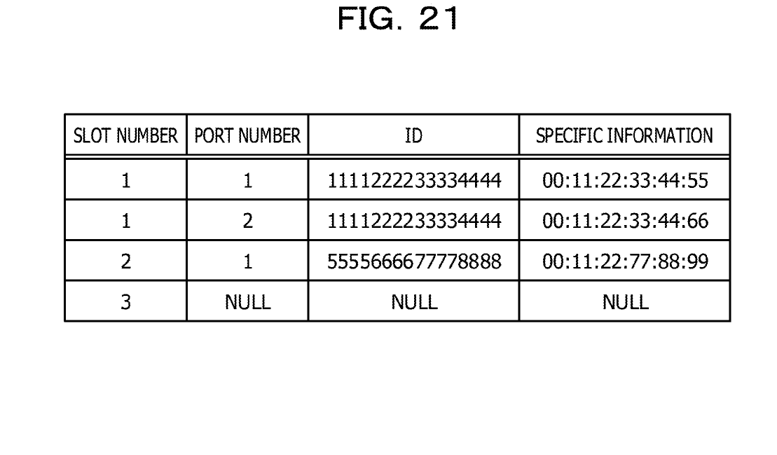

FIG. 21 is a diagram illustrating the long term storage table 31a before determination processing after the configuration change. The same information as the information of the long term storage table 41 illustrated in FIG. 19A is registered in the long term storage table 31a.

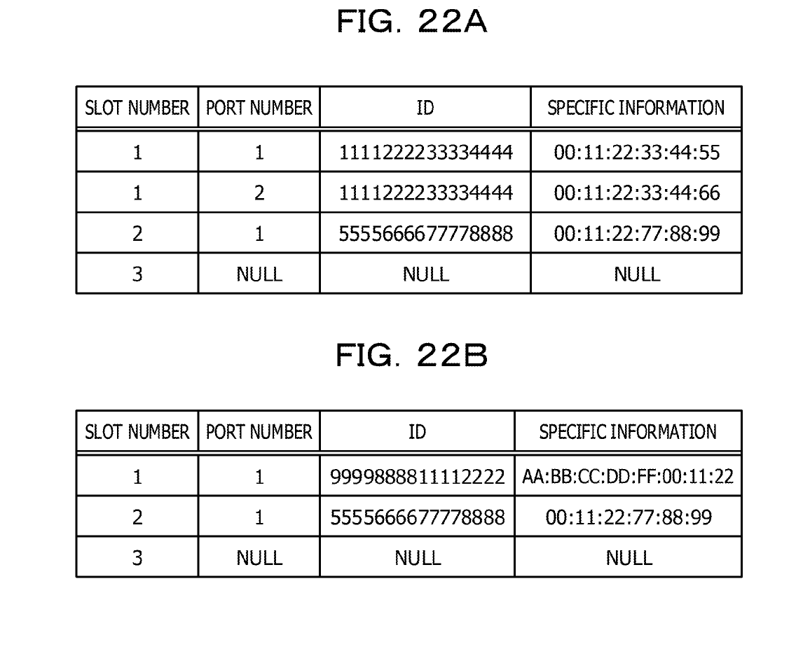

In the case of power-on after the configuration change, after the BIOS 23a performs initialization of the expansion card, the table preparing unit 44 develops the long term storage table 41 and the temporary storage table 42 illustrated in FIGS. 22A and 22B on the main memory 21 according to the flowchart of FIG. 6. As illustrated in FIG. 22B, an ID of the FC card D and a WWN of the port #1 are registered in the temporary storage table 42.

The redundancy processing unit 45 performs the redundancy processing according to the flowchart of FIG. 7. A card of the expansion slot #1 does not have specific information and an ID coinciding with specific information and an ID of the long term storage table 41. Therefore, the redundancy processing unit 45 determines that there is no redundancy. The expansion slots #2 and #3 are the same as the expansion slots #2 and #3 of the apparatus illustrated in FIG. 10. The redundancy processing unit 45 determines that there is no redundancy.

The specific-information determining unit 46 performs the specific information determination processing according to the flowchart of FIG. 8. Concerning the expansion slot #1, values of specific information of the temporary storage table 42 and the long term storage table 41 are other than NULL. IDs of the temporary storage table 42 and the long term storage table 41 are different. Therefore, the specific-information determining unit 46 overwrites values of the long term storage table 41 with values of the temporary storage table 42. The expansion slots #2 and #3 are the same as the expansion slots #2 and #3 of the apparatus illustrated in FIG. 10. The specific-information determining unit 46 performs the same processing as the processing explained concerning the apparatus illustrated in FIG. 10.

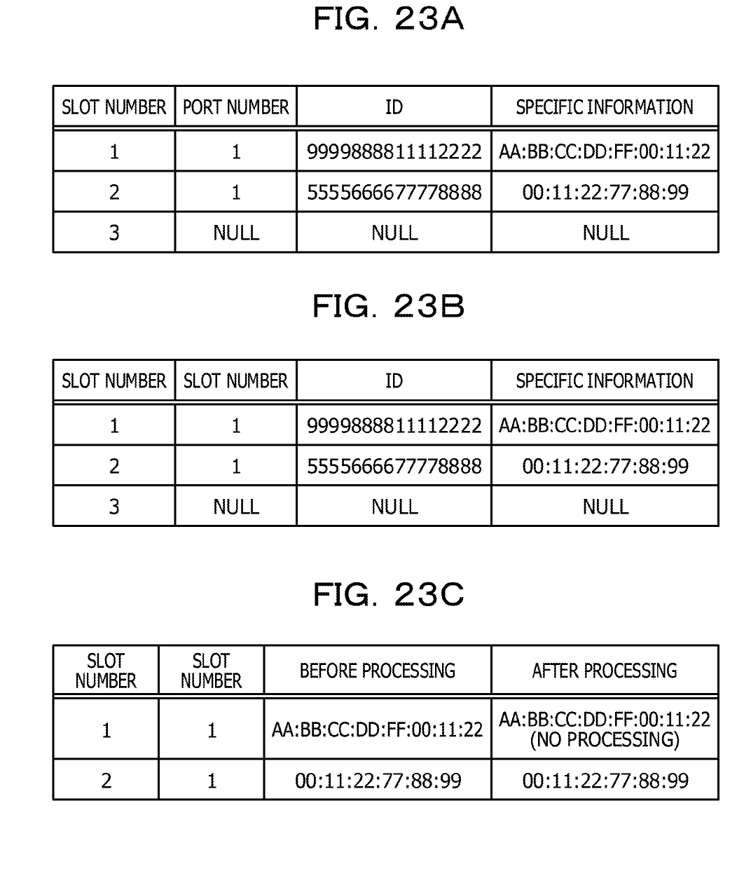

FIGS. 23A to 23C are diagrams illustrating the tables after the specific information determination processing after the configuration change and specific information retained by the controller. FIG. 23A illustrates the long term storage table 41. FIG. 23B illustrates the temporary storage table 42. FIG. 23C illustrates the specific information regained by the controller. As illustrated in FIG. 23A, concerning the expansion slot #1, an ID and specific information of the port #1 are overwritten with values of the temporary storage table 42. As illustrated in FIG. 23C, specific information retained by the controller concerning the expansion slot #1 is not changed.

After the processing on the expansion slot #3, the information processing apparatus 1a writes the long term storage table 41 in the flash memory 31 and boots the OS. When the inserted expansion card is changed to a card of a different system by the operation explained above, the information processing apparatus 1a may save changed information in the long term storage table 41 without the user performing work and thereafter determine specific information based on the information.

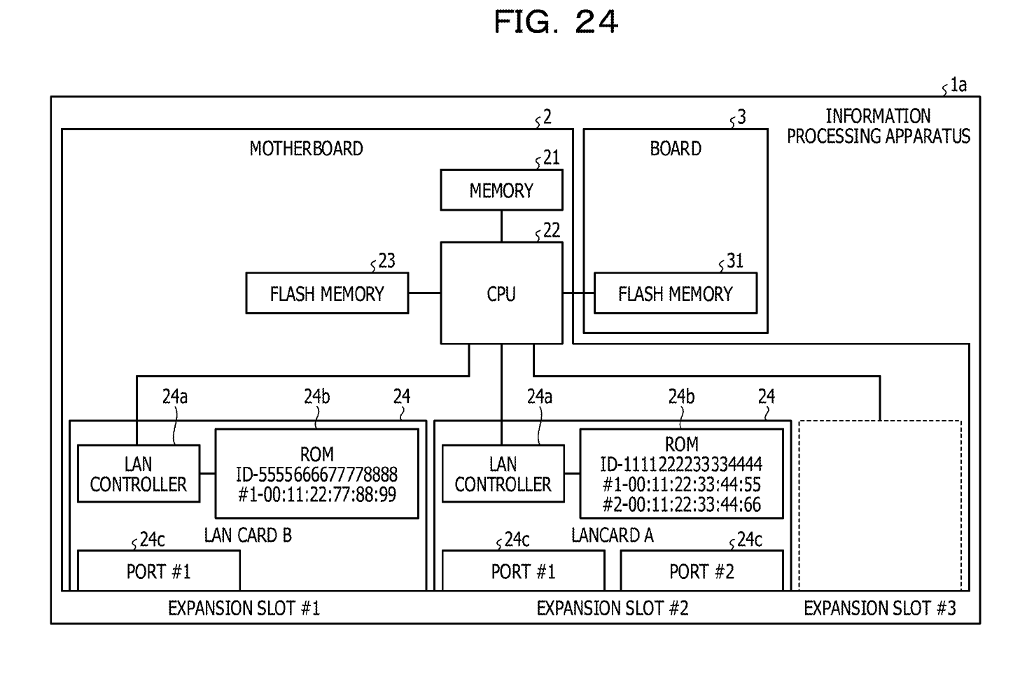

The operation of the information processing apparatus 1a at the time when position in an expansion slot of the LAN card 24 is replaced by the configuration change is explained. That is, operation in the case of the state transition Viii is explained concerning the expansion slot #1 and the expansion slot #2. Operation in the case of the state transition I is explained concerning the expansion slot #3. FIG. 24 is a diagram illustrating a hardware configuration after the LAN card 24 replacement. In FIG. 24, the LAN card A and the LAN card B are replaced compared with the information processing apparatus 1a illustrated in FIG. 10.

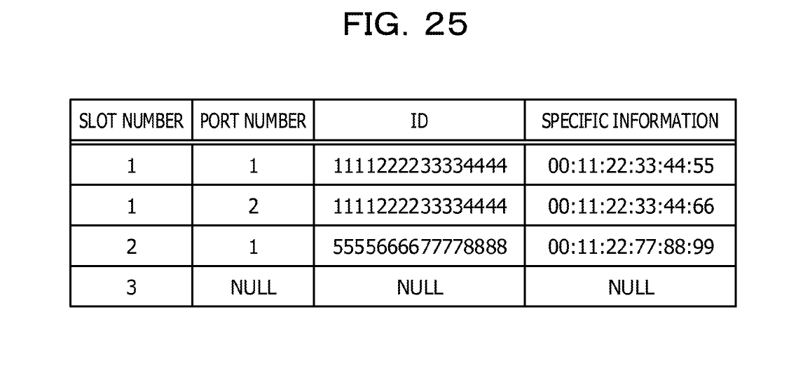

FIG. 25 is a diagram illustrating the long term storage table 31a before determination processing after the LAN card replacement. In the long term storage table 31a, the same information as the information of the long term storage table 41 illustrated in FIG. 13A is registered.

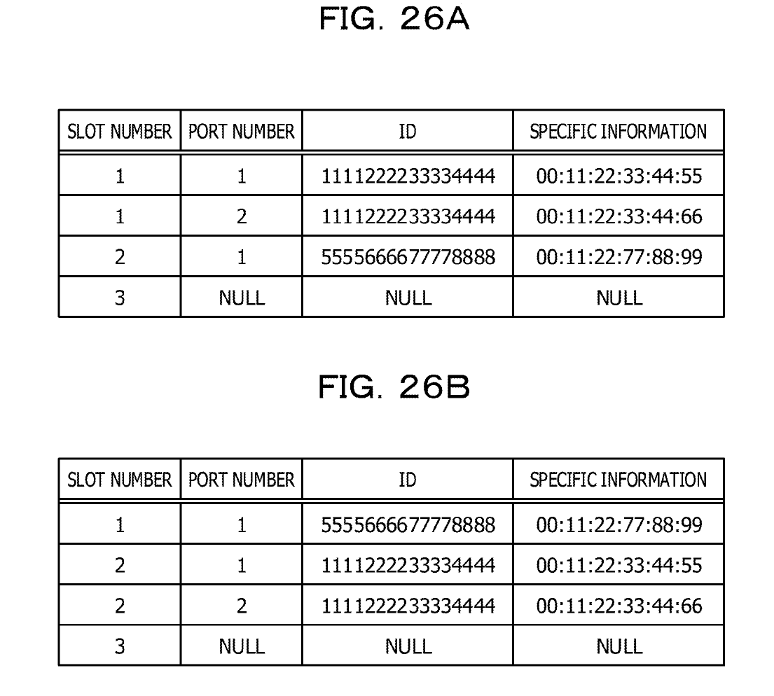

In the case of power-on after the replacement, after the BIOS 23a performs initialization of the expansion card, the table preparing unit 44 develops the long term storage table 41 and the temporary storage table 42 illustrated in FIGS. 26A and 26B on the main memory 21 according to the flowchart of FIG. 6. As illustrated in FIG. 26B, information is replaced in the expansion slot #1 and the expansion slot #2.

The redundancy processing unit 45 performs the redundancy processing according to the flowchart of FIG. 7. An ID and specific information of the expansion slot #1 of the temporary storage table 42 and an ID and specific information of the expansion slot #2 of the long term storage table 41 coincide with each other. Therefore, the redundancy processing unit 45 overwrites the port number, the ID, and the specific information of the expansion slot #2 of the long term storage table 41 with NULL. The expansion slot #2 of the temporary storage table 42 coincides with the expansion slot #1 of the long term storage table 41. Therefore, the redundancy processing unit 45 overwrites the port number, the ID, and the specific information of the expansion slot #1 of the long term storage table 41 with NULL. The expansion slot #3 is the same as the expansion slot #3 in the apparatus illustrated in FIG. 10. The redundancy processing unit 45 determines that there is no redundancy.

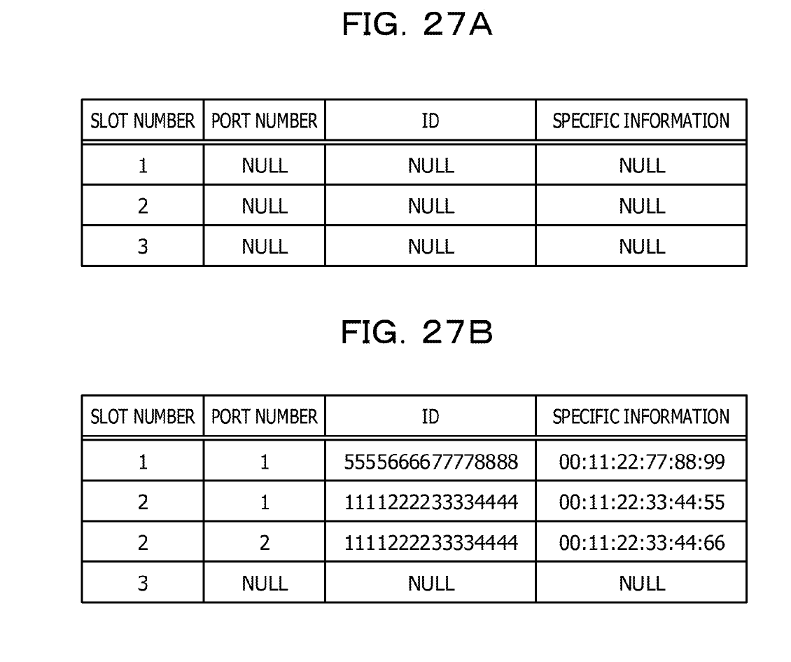

FIGS. 27A and 27B are diagrams illustrating the long term storage table 41 and the temporary storage table 42 after the redundancy processing after the LAN card replacement. FIG. 27A illustrates the long term storage table 41. FIG. 27B illustrates the temporary storage table 42. As illustrated in FIG. 27A, concerning the expansion slots #1 and #2, port numbers, IDs and specific information are overwritten with NULL.

The specific-information determining unit 46 performs the specific information determination processing according to the flowchart of FIG. 8. Concerning the expansion slot #1 and the expansion slot #2, there are values in IDs of the temporary storage table 42 and values of IDs of the long term storage table 41 is NULL. Therefore, the specific-information determining unit 46 writes values of the temporary storage table 42 in the long term storage table 41. The expansion slot #3 is the same as the expansion slot #3 of the apparatus illustrated in FIG. 10. The specific-information determining unit 46 performs the same processing as the processing explained concerning the apparatus illustrated in FIG. 10.

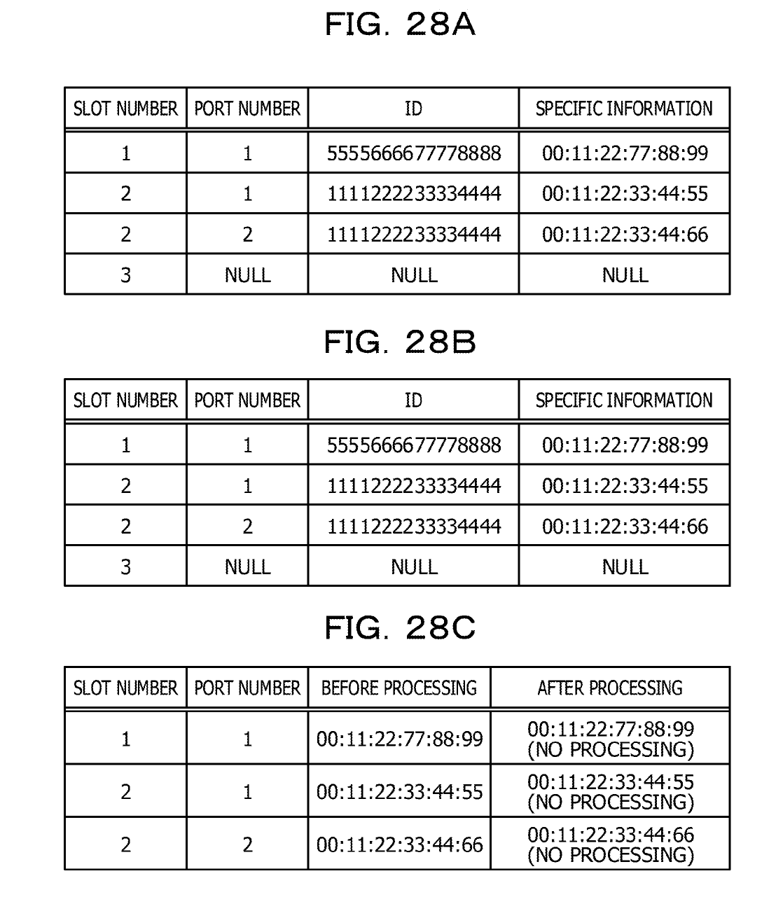

FIGS. 28A to 28C are diagrams illustrating the tables after the specific information determination processing after the LAN card replacement and MAC addresses retained by the LAN controller 24a. FIG. 28A illustrates the long term storage table 41, FIG. 28B illustrates the temporary storage table 42, and FIG. 28C illustrates specific information retained by the LAN controller 24a. As illustrated in FIG. 28A, concerning the expansion slot #1 and the expansion slot #2, the long term storage table 41 is overwritten with values of the temporary storage table 42. As illustrated in FIG. 28C, specific information retained by the LAN controller 24a concerning the expansion slot #1 and the expansion slot #2 is not changed.

After the processing on the expansion slot #3, the information processing apparatus 1a writes the long term storage table 41 in the flash memory 31 and boots the OS. When a position in an expansion slot of the LAN card 24 is replaced by the operation explained above, the information processing apparatus 1a may be able to reduce redundancy of MAC addresses without the user performing work.

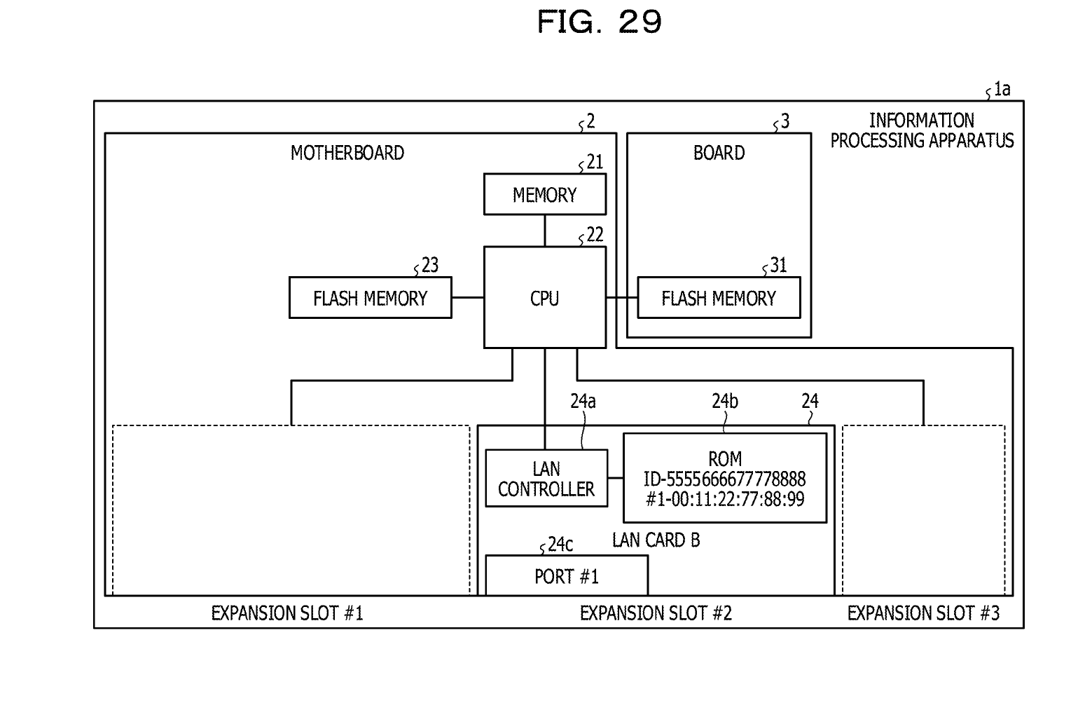

The operation of the information processing apparatus 1a at the time when an expansion card for communication is temporarily removed because of a failure is explained. That is, operation in the case of the state transition IV is explained concerning the expansion slot #1. Operation in the case of the state transition Vi is explained concerning the expansion slot #2. Operation in the case of the state transition I is explained concerning the expansion slot #3. FIG. 29 is a diagram illustrating a hardware configuration after the expansion card for communication removal. In FIG. 29, the LAN card A is removed compared with the information processing apparatus 1a illustrated in FIG. 10.

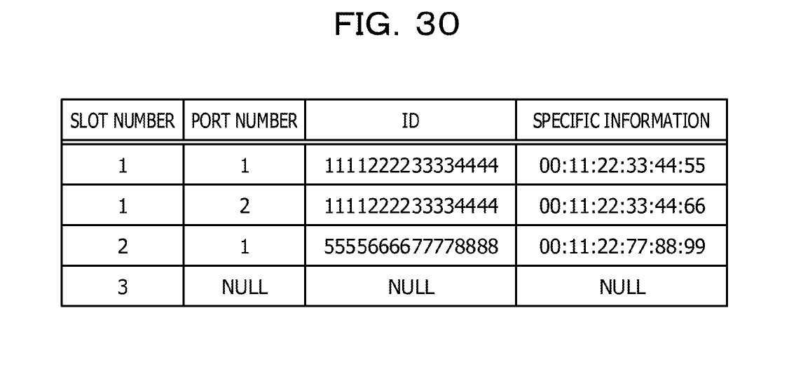

FIG. 30 is a diagram illustrating the long term storage table 31a before determination processing after the expansion card for communication removal. In the long term storage table 31a, the same information as the information of the long term storage table 41 illustrated in FIG. 13A is registered.

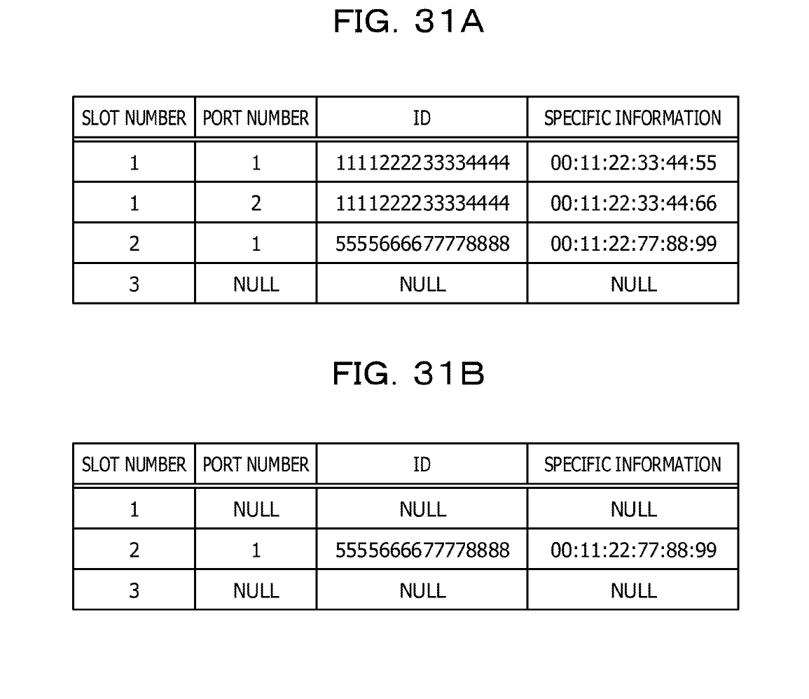

In the case of power-on after the expansion card for communication removal, after the BIOS 23a performs initialization of the expansion card, the table preparing unit 44 develops the long term storage table 41 and the temporary storage table 42 illustrated in FIGS. 31A and 31B on the main memory 21 according to the flowchart of FIG. 6. As illustrated in FIG. 31B, concerning the expansion slot #1, a port number, an ID, and specific information of the temporary storage table 42 are NULL.

The redundancy processing unit 45 performs the redundancy processing according to the flowchart of FIG. 7. In the expansion slot #1 of the temporary storage table 42, since an ID and specific information are NULL, the redundancy processing unit 45 determines that there is no redundancy. In the expansion slot #2 of the temporary storage table 42, since an ID coincides with an ID of the expansion slot #2 of the long term storage table 41, the redundancy processing unit 45 determines that there is no redundancy. The expansion slot #3 is the same as the expansion slot #3 of the apparatus illustrated in FIG. 10. The redundancy processing unit 45 determines that there is no redundancy.

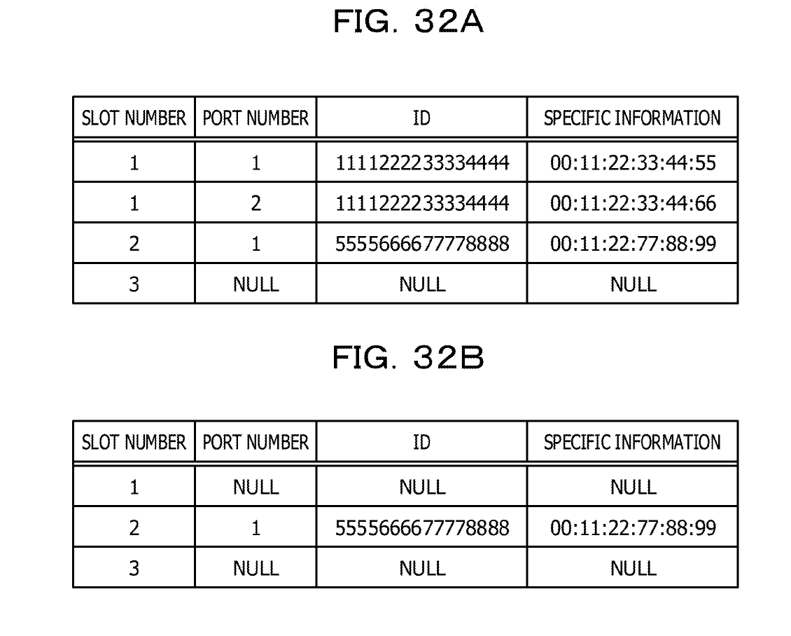

FIGS. 32A and 32B are diagrams illustrating the long term storage table 41 and the temporary storage table 42 after the redundancy processing after the expansion card for communication removal. FIG. 32A illustrates the long term storage table 41 and FIG. 32B illustrates the temporary storage table 42. As illustrated in FIG. 32A, the long term storage table 41 after the redundancy processing is the same as the long term storage table 41 before the redundancy processing illustrated in FIG. 31A.

The specific-information determining unit 46 performs the specific-information determination processing according to the flowchart of FIG. 8. Concerning the expansion slot #1, since values of specific information and a port number of the temporary storage table 42 are NULL, the specific-information determining unit 46 proceeds to the next expansion slot without changing anything. The expansion slot #2 and the expansion slot #3 are the same as the expansion slot #2 and the expansion slot #3 of the apparatus illustrated in FIG. 10. The specific-information determining unit 46 performs the same processing as the processing explained concerning the apparatus illustrated in FIG. 10.

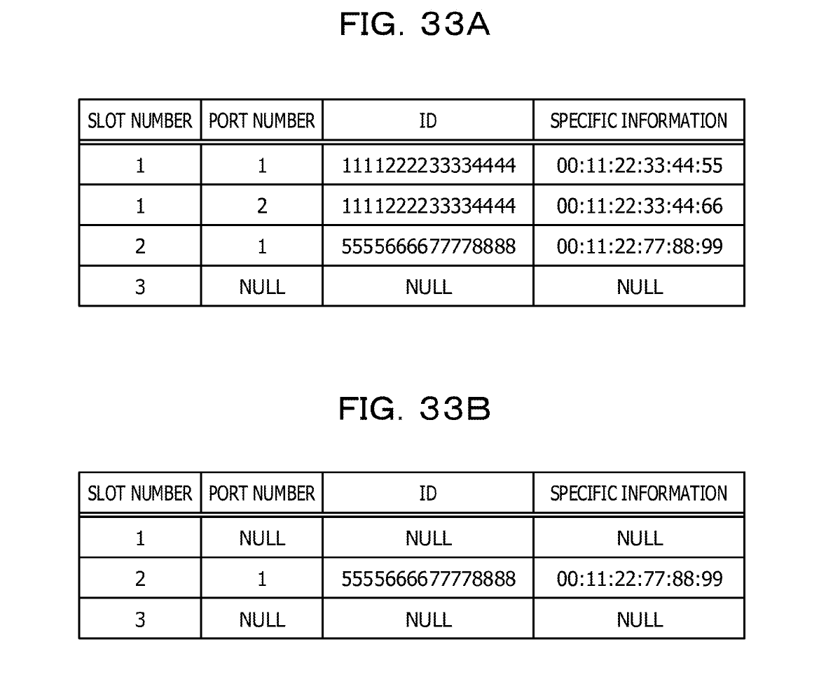

FIGS. 33A and 33B are diagrams illustrating the long term storage table 41 and the temporary storage table 42 after the specific-information determination processing after the expansion card for communication removal. FIG. 33A illustrates the long term storage table 41 and FIG. 33B illustrates the temporary storage table 42. As illustrated in FIG. 33A, information of the long term storage table 41 is the same before and after the expansion card for communication removal.

After the processing on the expansion slot #3, the information processing apparatus 1a writes the long term storage table 41 in the flash memory 31 and boots the OS. When the expansion card for communication is temporarily removed by the operation explained above, it is likely that the expansion card for communication is replaced with an expansion card for communication of the same system and the same type. Therefore, the information processing apparatus 1a may retain previous specific information.

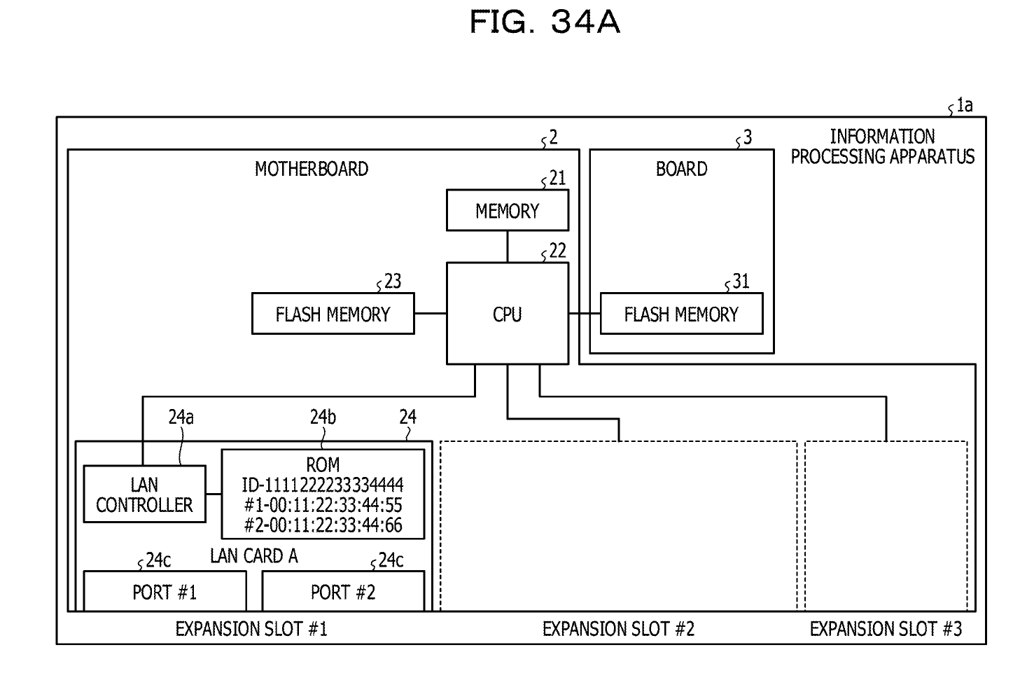

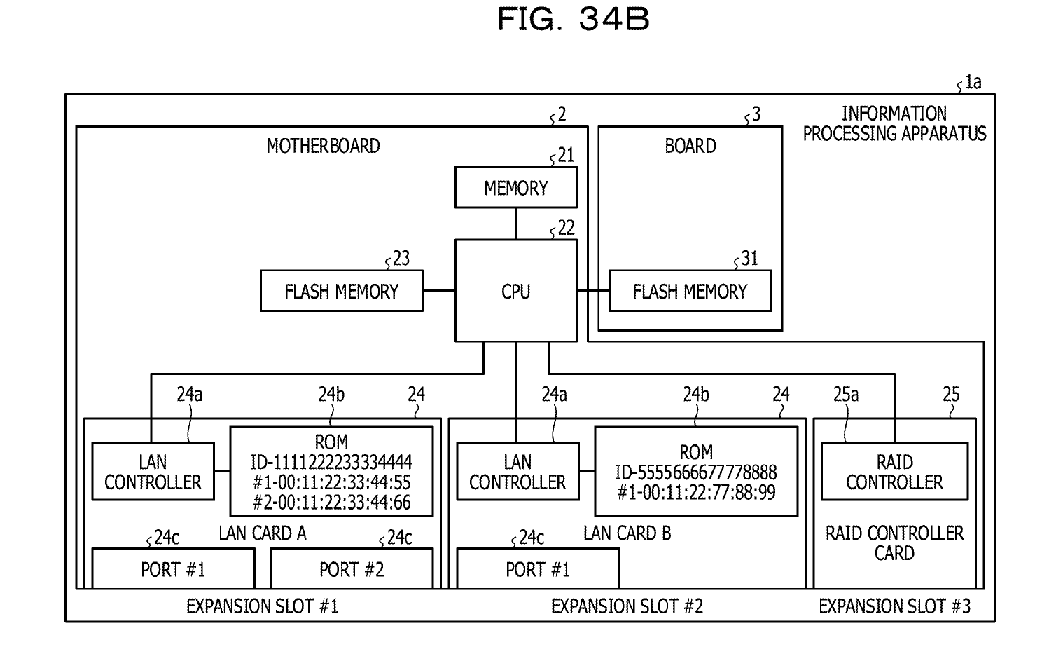

The operation of the information processing apparatus 1a at the time when an expansion card is added is explained. That is, operation in the case of the state transition Vi is explained concerning the expansion slot #1. Operation in the case of the state transition II is explained concerning the expansion slot #2. Operation in the case of the state transition III is explained concerning the expansion slot #3. FIG. 34A is a diagram illustrating a hardware configuration before the expansion card addition. FIG. 34B is a diagram illustrating a hardware configuration after the expansion card addition. In FIG. 34B, the LAN card B is added to the expansion slot #2. A RAID controller card 25 including a RAID controller 25a is added to the expansion slot #3.

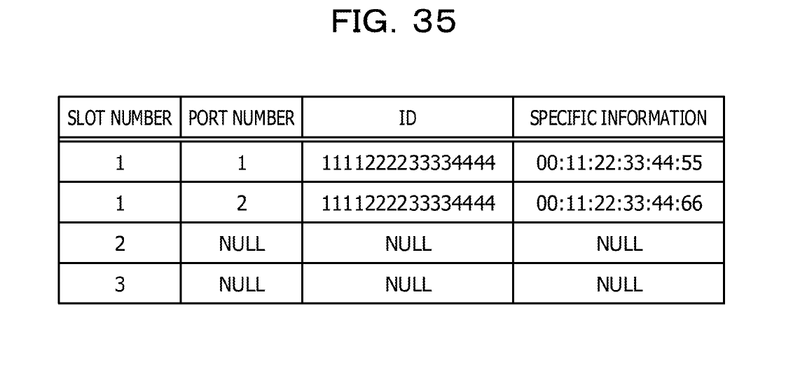

FIG. 35 is a diagram illustrating the long term storage table 31a before determination processing after the expansion card addition. As illustrated in FIG. 35, concerning the expansion slot #2 and the expansion slot #3 of the long term storage table 31a, a port number, an ID, and specific information are NULL.

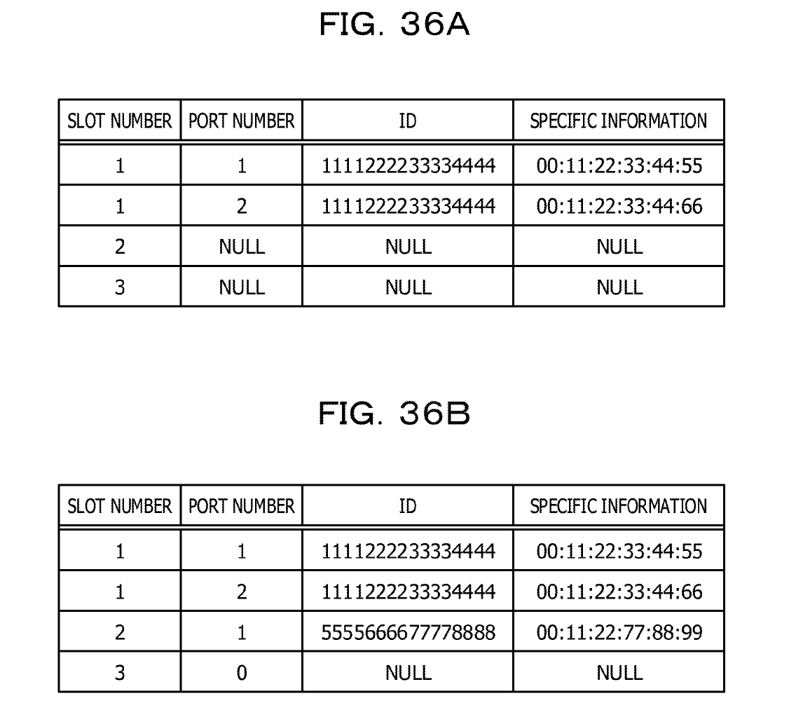

In the case of power-on after the expansion card addition, after the BIOS 23a performs initialization of the expansion card, the table preparing unit 44 develops the long term storage table 41 and the temporary storage table 42 illustrated in FIGS. 36A and 36B on the main memory 21 according to the flowchart of FIG. 6. As illustrated in FIG. 36B, information concerning the LAN card B is registered in the port #1 of the expansion slot #2 of the temporary storage table 42. Since the RAID controller card 25 is added to the expansion slot #3, a port number of the expansion slot #3 of the temporary storage table 42 is 0.

The redundancy processing unit 45 performs the redundancy processing according to the flowchart of FIG. 7. Concerning the expansion slot #1 of the temporary storage table 42, since an ID coincides with an ID of the expansion slot #1 of the long term storage table 41, the redundancy processing unit 45 determines that there is no redundancy. Concerning the expansion slot #2 of the temporary storage table 42, since specific information does not coincide with any specific information of the long term storage table 41, the redundancy processing unit 45 determines that there is no redundancy. Concerning the expansion slot #3, since specific information is NULL, the redundancy processing unit 45 determines that there is no redundancy.

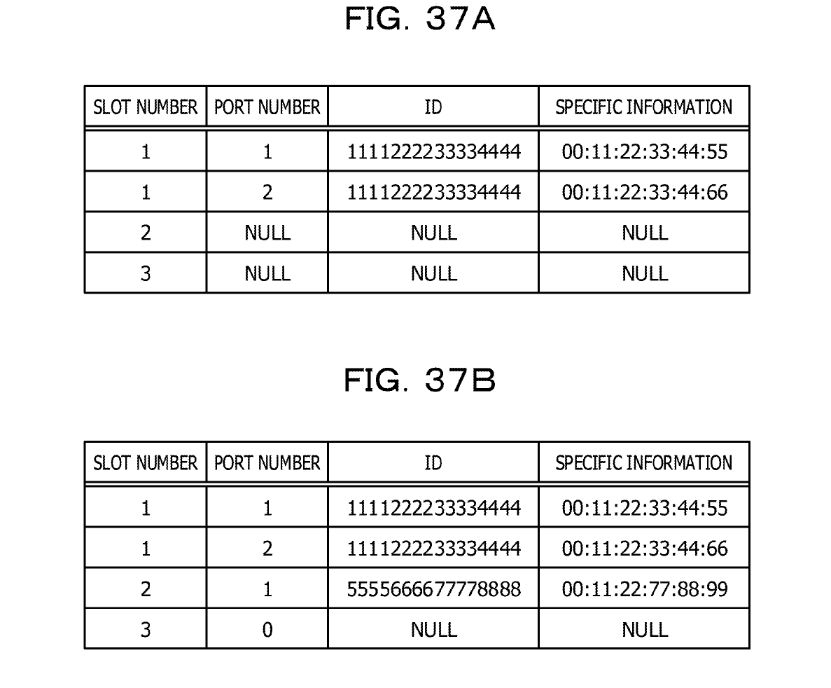

FIGS. 37A and 37B are diagrams illustrating the long term storage table 41 and the temporary storage table 42 after the redundancy processing after the expansion card addition. FIG. 37A illustrates the long term storage table 41 and FIG. 37B illustrates the temporary storage table 42. As illustrated in FIG. 37A, the long term storage table 41 after the redundancy processing is the same as the long term storage table 41 before the redundancy processing illustrated in FIG. 36A.

The specific-information determining unit 46 performs the specific-information determination processing according to the flowchart of FIG. 8. Concerning the expansion slot #1, a value of specific information of the temporary storage table 42 is other than NULL and IDs of the temporary storage table 42 and the long term storage table 41 coincide with each other. Therefore, the specific-information determining unit 46 overwrites MAC addresses of the port #1 and the port #2 retained by the LAN controller 24a of the LAN card A with values of MAC addresses stored in the long term storage table 41. Concerning the expansion slot #2, since an ID of the long term storage table 41 is NULL, the specific-information determining unit 46 writes a value of the expansion slot #2 of the temporary storage table 42 in the long term storage table 41. Concerning the expansion slot #3, since a port number of the temporary storage table 42 is 0, the specific-information determining unit 46 rewrites a port number, an ID and specific information of the expansion slot #3 of the long term storage table 41 to NULL.

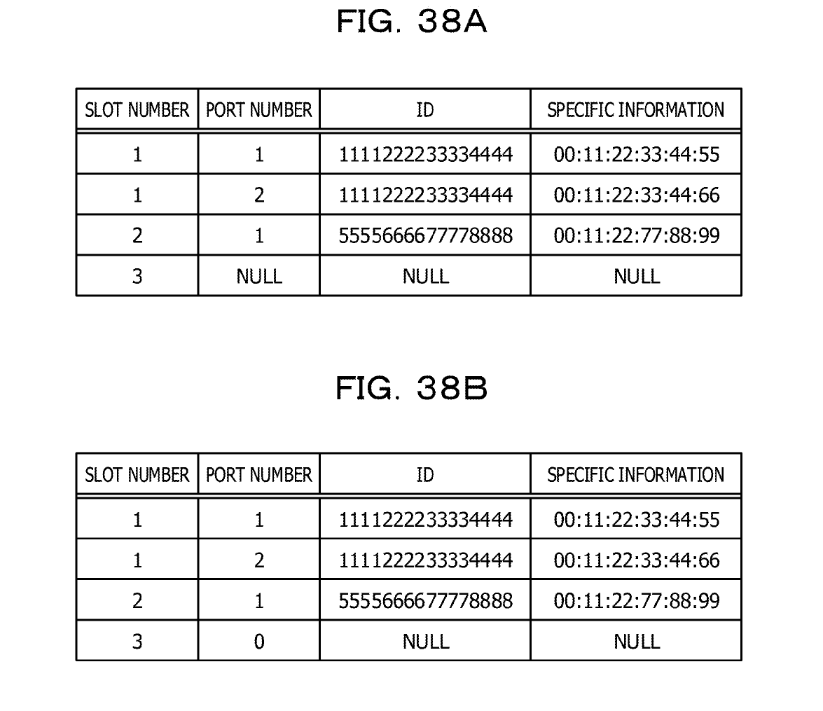

FIGS. 38A and 38B are diagrams illustrating the long term storage table 41 and the temporary storage table 42 after the specific information determination processing after the expansion card addition. FIG. 38A illustrates the long term storage table 41. FIG. 38B illustrates the temporary storage table 42. As illustrated in FIG. 38A, concerning the expansion slot #2, the long term storage table 41 is rewritten with the information of the temporary storage table 42.

After the processing on the expansion slot #3, the information processing apparatus 1a writes the long term storage table 41 in the flash memory 31 and boots the OS. When an expansion card is added by the operation explained above, by adding information to the long term storage table 41 anew, the information processing apparatus 1a may subsequently operate with the added information of the expansion card. When an expansion card for use other than communication is added, since the expansion card does not include specific information, the information processing apparatus 1a does not add specific information to the long term storage table 41.

Note that, concerning the state transition VII, since a port number, an ID, and specific information of the long term storage table 41 before the replacement are NULL, operation is the same as the operation in the state transition I. Concerning the state transition VIII, since a port number, an ID, and specific information of the long term storage table 41 before the replacement are NULL, operation is the same as the operation in the state transition II. Concerning the state transition IX, since a port number, an ID, and specific information of the long term storage table 41 before the replacement are NULL, operation is the same as the operation in the state transition III.

As explained above, in the first embodiment, the deciding unit 46a determines whether the system and the type of the inserted expansion card for communication are the same as the system and the type of the expansion card for communication before the replacement. When the system and the type are the same, the control unit 46b performs control to use the specific information of the expansion card for communication before the replacement. When the system or the type is different, the control unit 46b performs control to use the specific information of the expansion card for communication after the replacement. Therefore, during a network boot, the information processing apparatus 1 may continuously operate without changing setting of a DHCP server and a zone before and after the replacement of the expansion card for communication. The information processing apparatus 1 may enable addition of an expansion card for communication without preparing specific information in advance. The information processing apparatus 1 may enable extension of an expansion card for communication without providing a limitation concerning the number of pieces of specific information.

In the first embodiment, the redundancy processing unit 45 compares the slot number, the ID, and the specific information of the long term storage table 41 with the respectively expansion slots of the temporary storage table 42 and determines presence or absence of redundancy. When there is redundancy, the redundancy processing unit 45 invalidates redundant information of the long term storage table 41. Therefore, the information processing apparatus 1 may be able to reduce redundancy of the specific information.

In the first embodiment, the specific-information determining unit 46 saves the long term storage table 41 in the flash memory 31 as the long term storage table 31a. The table preparing unit 44 reads out the long term storage table 31a from the flash memory 31 and writes the long term storage table 31a in the main memory 21 as the long term storage table 41. Therefore, the information processing apparatus 1 may store the information of the long term storage table 41 even when the power supply is turned off.

### Second Embodiment

Incidentally, in the first embodiment, the latest long term storage table 41 is stored in the flash memory 31 as the long term storage table 31a. However, it is conceivable that the LAN card 24 breaks down and the LAN card 24 of a different type is used until the LAN card 24 is replaced with the LAN card 24 of the same type. In this case, the long term storage table 31a is updated when the LAN card 24 of the different type is used. The specific information of the originally inserted LAN card 24 is lost. Therefore, in the second embodiment, an information processing apparatus is explained that rolls back to the long term storage table 31a at the time when the original LAN card 24 is inserted to cause the replacing LAN card 24 to succeed the specific information of the original LAN card.

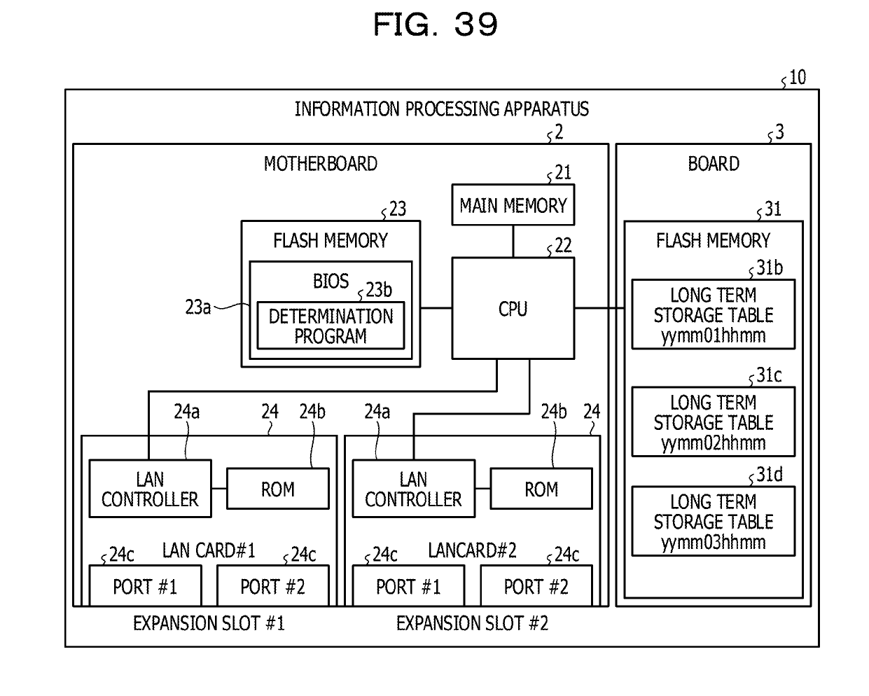

FIG. 39 is a diagram illustrating a hardware configuration of an information processing apparatus 10 according to the second embodiment. Note that, for convenience of explanation, components playing the same roles as the roles of the units illustrated in FIG. 1 are denoted by the same reference numerals and signs and detailed explanation of the components is omitted.

As illustrated in FIG. 39, the flash memory 31 stores three long term storage tables 31b, 31c, and 31d. The long term storage tables 31b, 31c, and 31d are managed according to times when the long term storage tables 31b, 31c, and 31d are saved. In the figure, “yymm01hhmm” to “yymm03hhmm” indicate the times when the long term storage tables 31b, 31c, and 31d are saved. The long term storage table 31b is the oldest, the long term storage table 31c is the second oldest, and the long term storage table 31d is the newest. Note that, although the flash memory 31 stores the three long term storage tables 31b, 31c, and 31d, the flash memory 31 may store a larger number of long term storage tables. The flash memory 31 may store two long term storage tables.

The table preparing unit 44 reads the newest long term storage table 31d into the main memory 21 from the flash memory 31. Therefore, after powering on the information processing apparatus 10, a user actuates interrupt processing by pressing a function key immediately before the table preparing unit 44 operates. When the rollback is not performed, the user does not press the function key. When the rollback is performed, the user presses the function key to cause the interrupt processing.

An interrupt processing unit displays a plurality of long term storage tables on a screen and causes the user to select one long term storage table. The interrupt processing unit copies the selected long term storage table and set saving time to present time. The table preparing unit 44 reads the latest long term storage table into the main memory 21 from the flash memory 31. Consequently, the information processing apparatus 10 may roll back to the long term storage table designated by the user.

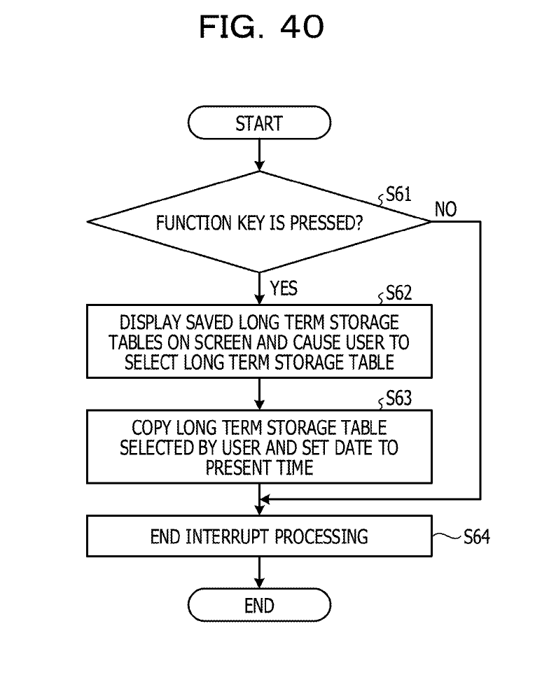

FIG. 40 is a flowchart illustrating a flow of processing by the interrupt processing unit. As illustrated in FIG. 40, the interrupt processing unit determines whether the function key is pressed (step S61). When the function key is not pressed, the interrupt processing unit proceeds to step S64.

On the other hand, when the function key is pressed, the interrupt processing unit displays the saved long term storage tables on the screen and causes the user to select a long term storage table (step S62). The interrupt processing unit copies the long term storage table selected by the user and sets a date as the present time (step S63). The interrupt processing unit ends the interrupt processing (step S64).

As explained above, in the second embodiment, the interrupt processing unit copies the long term storage table selected by the user and sets a date of the copied long term storage table as the present time. Consequently, the information processing apparatus 10 may roll back to the long term storage table designated by the user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
determine whether a system and a type of an expansion card for communication inserted in a replaceable form are same as a system and a type of an expansion card for communication before replacement;
when determining that the system and the type are the same, set specific information of the expansion card for communication before the replacement; and
when determining that the system or the type is different, set specific information of the expansion card for communication after the replacement.

2. The information processing apparatus according to claim 1, wherein the information processing apparatus into which a plurality of the expansion cards for communication are inserted, the information processing apparatus further comprising:
a first storing unit configured to store the specific information of the expansion card for communication after the replacement in association with an inserting place; and
a second storing unit configured to store the specific information of the expansion card for communication before the replacement in association with an inserting place, and
the processor determines redundancy of the specific information based on whether the specific information stored in association with a first inserting place of the first storing unit is equal to the specific information stored in association with a second inserting place different from the first inserting place of the second storing unit.

3. The information processing apparatus according to claim 2, wherein
the processor reads out the specific information of the expansion card for communication before the replacement from a nonvolatile memory mounted on a board different from a motherboard and writes the specific information in the second storing unit and reads out the specific information from the inserted expansion card for communication and writes the specific information in the first storing unit.

4. The information processing apparatus according to claim 2, wherein
the first storing unit stores a card identifier representing the system and the type of the expansion card for communication in addition to the specific information,
the second storing unit stores a card identifier representing the system and the type of the expansion card for communication in addition to the specific information, and
the processor determines the redundancy of the specific information based on the card identifiers.

5. The information processing apparatus according to claim 3, wherein
the processor reads out, from the nonvolatile memory, the specific information designated by a user among a plurality of kinds of the specific information and writes the specific information in the second storing unit.

6. The information processing apparatus according to claim 1, wherein
the system of the expansion card for communication is one of systems including a system of a LAN card, a system of a Fibre Channel card, and a system of an InfiniBand card, and
the type of the expansion card for communication is one of types including a type based on a mounted chip, a type based on communication speed, and a type based on a number of ports.

7. A starting method comprising:
determining, by a processor, whether a system and a type of an expansion card for communication inserted in a replaceable form are same as a system and a type of an expansion card for communication before replacement;
when determining that the system and the type are the same, setting, by a processor, specific information of the expansion card for communication before the replacement; and
when determining that the system or the type is different, setting, by a processor, specific information of the expansion card for communication after the replacement.
